(19) United States
(12) Patent Application Publication
(10) Pub. No.: US 2023/0286425 A1
(43) Pub. Date: Sep. 14, 2023

(54) SYSTEM AND METHOD FOR PROTECTING AN OCCUPANT IN A REAR IMPACT OF A VEHICLE

(71) Applicant: Institute for Injury Research, Bloomfield Hills, MI (US)

(72) Inventor: David C. Viano, Bloomfield Hills, MI (US)

(21) Appl. No.: 17/693,977

(22) Filed: Mar. 14, 2022

(51) Int. Cl. B60N 2/42; B60R 22/195

(52) U.S. Cl. CPC B60N 2/4228; B60R 22/1954; B60R 22/1951

(57) ABSTRACT

A system (100) and method (900) for assessing for protecting the occupant (70) of a vehicle (50) during a rear crash (62). The system (100) can use a wide variety of assemblies, subassembly, and component configurations to protect the occupant (70) from undesirable kinematics (91). Such a system (100) can among other components include an anti-ramping guide (272) and/or a rear pretensioner (305).

### BACKGROUND OF THE INVENTION

The invention relates generally to the systems and methods for protecting the occupant of a vehicle. More specifically, the invention is a system and method for protecting the occupant of a vehicle during a rear collision (collectively, the “system”).

According to the National Highway Traffic Safety Administration, 31.1% of vehicle crashes involving injury in the United States in 2019 were rear collisions. (NHTSA. Traffic Safety Facts 2019. US Department of Transportation, National Highway Traffic Safety Administration, DOT HS 813 141, Washington D.C., August 2021). Nationwide there were 595,000 injuries and 2,346 fatalities resulting from rear crashes in 2019.

While rear crashes involve the lowest risk for serious injury relative to other crash types, the death and injury numbers cited above show that further improvements are needed in rear impacts. (Viano D C, Parenteau C S. Injury by Delta V in Front, Near-Side, Far-Side and Rear Impacts: Analysis of 1994-2015 NASS-CDS. SAE 2022-01-0835, Society of Automotive Engineers, Warrendale, Pa., 2022). In a rear impact, it is the seat that provides essentially all of the occupant restraint as seatbelts are designed to protect occupants in frontal impacts. Seatbelts provide essentially no occupant restraint in rear impacts with a change in velocity (ΔV) up to 48 km/h (25 mph). This is true even with retractor or buckle pretensioner activation in rear impacts up to 48 km/h (25 mph) severity with modern seats. (Viano D C, Parenteau C S, Burnett R. Influence of Belt Pretensioning on Dummy Responses in 40 km/h Rear Impact Sled Tests. Traffic Injury Prevention, 13(1):65-71, 2012); Viano D C, Burnett R, Miller G A, Parenteau C S. Influence of Retractor and Anchor Pretensioning on Dummy Responses in 40 km/h Rear Sled Tests. Traffic Injury Prevention, 22:5, 396-400, 2021).

Prior art technologies in the field of occupant safety have focused on front, side and rollover accidents with only a limited scope of technologies for rear collisions. The undesirable occupant kinematics of those accidents are vastly different than the undesirable occupant kinematics of a rear collision. As a result, the undesirable occupant kinematics in a rear collision need different technologies for occupant protection than found in prior art. In a front collision, one needs to restrain the occupant from forward movement on the seat. In a rear collision, one wants to prevent the occupant from “ramping” backwards and upwards on the seat. Prior art technologies such as airbags and safety belts inherently address movement in front, side and rollover crashes while having limited or no obvious application to mitigate the impact of most rear impacts. The prior art does not teach a means to get early restraint from seatbelts in rear impacts or control H-point and torso angle motion so there is no ramping.

The system is described in greater detail below in the Summary of the Invention section.

### SUMMARY OF THE INVENTION

The invention relates generally to the systems and methods for protecting the occupant of a vehicle. More specifically, the invention is a system and method for protecting the occupant of a vehicle during a rear collision (collectively, the “system”).

The system can be implemented in a variety of different configurations using a variety of different assemblies, subassemblies, and components. The system can protect vehicle occupants by preventing undesirable occupant kinematics during a rear collision. During a rear impact, the system can direct the movement of the occupant in such a manner that the occupant experiences desirable occupant kinematics.

Some embodiments of the system achieve desirable occupant kinematics and avoid undesirable kinematics by using a rear pretensioner within the belt assembly. Other embodiments can utilize an anti-ramping guide within the seat assembly. Still other embodiments can utilize both components.

The system can be better understood by referencing the drawings discussed below.

### BRIEF DESCRIPTION OF THE DRAWINGS

Different examples of various attributes, components, and configurations that can be incorporated into the system are illustrated in the drawings described briefly below. No patent application can expressly disclose all of the potential embodiments of an invention through the use of words or drawings. In accordance with the provisions of the patent statutes, the principles, functions, and modes of operation of the system are illustrated in certain preferred embodiments. The system may be practiced by other means than are specifically illustrated without departing from its spirit or scope.

FIG. 1A is diagram illustrating an example of a top view of rear collision between two vehicles.

FIG. 1B is a diagram illustrating an example of a side view of occupant in a seated position.

FIG. 1C is a diagram illustrating an example of a side view of a torso of an occupant.

FIG. 1D is a diagram illustrating an example of a side view of a torso experiencing undesirable kinematics during a rear collision.

FIG. 1E is a diagram illustrating an example of a side view of a torso experiencing desirable kinematics during a rear collision.

FIG. 1F is a diagram illustrating an example of a side view of an occupant experiencing desirable kinematics while moving within a vehicle during a rear collision.

FIG. 1G is a diagram illustrating an example of a side view of an occupant experiencing undesirable kinematics while moving within a vehicle during a rear collision.

FIG. 1H is a diagram illustrating an example of a side view of an occupant and the load areas on the occupant with desirable kinematics during a rear collision.

FIG. 2A is a block diagram of a system that includes a seat assembly with an anti-ramping guide and/or a belt assembly with a rear-pretensioner.

FIG. 2B is a block diagram illustrating an example of the sub-assemblies and components that can be used in a seat assembly.

FIG. 2C is a block diagram illustrating an example of the sub-assemblies and components can be used within a belt assembly.

FIG. 3A is a diagram illustrating an example of a perspective view of a seat assembly with an anti-ramping guide.

FIG. 3B is a close-up view of the deformable brackets and shell of the seat assembly in FIG. 3A.

FIG. 3C is a side view diagram illustrating an example of an occupant positioned relative to the deformable brackets and shell of the seat assembly with an anti-ramping guide.

FIG. 3D is a side view diagram illustrating an example of the deployment of an anti-ramping guide during a rear collision.

FIG. 3E is a diagram that resembles FIG. 3B except that it illustrates an example of a high-back shell as an alternative to the shell of FIG. 3B.

FIG. 3F is a diagram that resembles FIG. 3A except that it illustrates an example of a high-back shell as an alternative to the shell of FIG. 3A with the recliners higher up the seatback.

FIG. 3G is a diagram that resembles FIG. 3E except that it illustrates an example a high-back shell as an alternative to the shell of FIG. 3E.

FIG. 3H is a diagram that resembles FIG. 3E except that it illustrates an example a high-back shell as an alternative to the shell of FIG. 3E.

FIG. 3I is a perspective diagram illustrating an example of a seat assembly with release brackets and pivots for the cushion support.

FIG. 4A is a side view diagram illustrating an example of a belt assembly with the rear pretensioner changing the anchor location.

FIG. 4B is a diagram illustrating an example of different components of a belt assembly.

FIG. 4C is a perspective diagram illustrating an example of components of the belt assembly and rear pretensioner components as they are positioned relative to the seat assembly.

FIG. 4D is a side view diagram illustrating an example a rear pretensioned seatbelt assembly preventing undesirable kinematics in the context of a rear impact.

FIG. 4E is a perspective diagram illustrating an example of a belt assembly that includes a wrap-around lap belt and two pretension actuators.

FIG. 4F is a diagram that resembles FIG. 4E except that is illustrates an example of a rotating spindle that uses a single pyrotechnic actuator.

FIG. 5A is a diagram that illustrates an example of a side view of a system prior to a rear impact collision that includes both an anti-ramping guide within the seat assembly and the cable tightening functionality pulling the cushion support down that is triggered by a pyrotechnic actuator in the event of a rear impact.

FIG. 5B is a side view diagram that corresponds to the configuration of components in FIG. 5A during a rear collision.

FIG. 6A is a flow chart diagram illustrating an example of the system being used to obtain desirable occupant kinematics by directing the movement of the occupant in rear impact.

FIG. 6B is a flow chart diagram illustrating an example of an anti-ramping guide being deployed to direct the movement of an occupant in a rear collision.

FIG. 6C is a flow chart diagram illustrating an example of a rear-pretensioner being used to tighten one or more safety belts and change the anchor location to direct the movement of an occupant in a rear collision.

FIG. 6D is a flow chart diagram illustrating an example of the method utilizing the components of the seat assembly to direct the movement of an occupant in a rear collision.

FIG. 6E is a flow chart diagram illustrating an example of the method utilizing the components of the belt assembly to direct the movement of an occupant in a rear collision.

The system can be further understood by the text description provided below in the Detailed Description section.

### DETAILED DESCRIPTION

The invention relates generally to the systems and methods for protecting the occupant of a vehicle. More specifically, the invention is a system and method for protecting the occupant of a vehicle during a rear collision (collectively, the “system”).

The system can use an anti-ramping guide within the seat assembly, a rear pretensioner within the belt assembly, or both an anti-ramping guide and a rear pretensioner to direct the movement of a vehicle occupant in such a manner as to avoid undesirable occupant kinematics.

Embodiments utilizing a rear pretensioner can change the anchor locations for the lap belt in response to a rear impact. By moving them up and forward on the seat frame the lap belt creates restraining forces early in a rear impact. The new anchor locations can shorten the length of webbing, and for embodiments that include an anti-ramping guide, the new anchor locations can pull the hip and thighs down into an anti-ramping guide through a small diameter arc.

Embodiments using an anti-ramping guide use the component to direct the movement of the occupant's hip during a rear end collision. The guide can be composed of a shell with the contour of the back and bottom of the pelvis and deformable brackets attached to the seat cushion frame. The trajectory of the anti-ramping guide can cause the pelvis to move rearward and downward providing favorable occupant kinematics in a rear impact.

Embodiments utilizing a combination of rear pretensioner and anti-ramping guide to control occupant kinematics can be particularly effective in protecting occupants by working together during rear collision as the functions of the rear-pretensioner within the belt assembly and the anti-ramping guide within the seat assembly can reinforce each other to better avoid undesirable occupant kinematics. The dynamic release of the cushion support can further enhance desirable occupant kinematics by lowering the seat and the occupant.

### I. ALTERNATIVE EMBODIMENTS

The system can be implemented in a wide variety of different embodiments with different configurations of assemblies, subassemblies, and components. No patent application can expressly disclose, whether in words or in drawings, all of the potential embodiments of an innovative system in truly a comprehensive manner. In accordance with the provisions of the patent statutes, the principles, functions, and modes of operation of the system are illustrated in certain desirable embodiments. The system may be practiced in many configurations, components, and operating contexts other than specifically illustrated without departing from its spirit or scope.

### II. GLOSSARY OF TERMS

All terminology associated with an element number is defined in Table 1 below.

TABLE 1

| ELEMENT | | ELEMENT DEFINITION AND |
|---|---|---|
| # | ELEMENT NAME | DESCRIPTION |
| 50 | VEHICLE | A machine that transports people |
| | | and/or cargo. Vehicles 50 include |
| | | wagons, bicycles, motor vehicles, |
| | | railed vehicles, watercraft, and |
| | | spacecraft. The system 100 was |
| | | originally conceptualized in the |
| | | context of automobiles 52, but the |
| | | system 100 can be implemented in a |
| | | wide range of vehicles 50. |
| 52 | Automobile | A road vehicle 50, typically with four |
| | | wheels powered by an electric motor |
| | | or an internal combustion engine. |
| 60 | IMPACT or CRASH | A collision involving a vehicle 50. |
| | | Impacts 60 can be categorized on the |
| | | basis of the direction of the impact 60, |
| | | such as rear 62, front 64, and side 66. |
| | | The system 100 was originally |
| | | conceptualized in the context of rear |
| | | impacts 62 to automobiles 52, but it |
| | | can be implemented for other vehicles |
| | | 50 and other contexts. The frame of |
| | | reference for what constitutes |
| | | forward, rear, and side is from the |
| | | perspective of an occupant 70 seated |
| | | in the seat assembly 200 facing |
| | | towards the dashboard and steering |
| | | mechanisms in the vehicle 50. |
| 62 | Rear Impact or Rear Crash | A collision where the vehicle 50 is |
| | | impacted from behind, typically by |
| | | another vehicle 50. In a rear crash 62, |
| | | the principal force vector is typically |
| | | between +/−30° from a 180° rear |
| | | collision (from 150° to 210° with 0° |
| | | representing the front). |
| 64 | Front Impact or Front Crash | A collision where the vehicle 50 is |
| | | impacted at the forward portion of the |
| | | vehicle 50, typically by the vehicle 50 |
| | | driving into another vehicle 50 or |
| | | some structure or object in front of the |
| | | vehicle 50. In a front crash 64, the |
| | | principal force vector is typically |
| | | between +/−30° from a 0° front |
| | | collision (from −30° to 30° with 0° |
| | | representing the front). |
| 66 | Side Impact or Side Crash | A collision where the vehicle 50 is |
| | | impacted laterally. In a side crash 66, |
| | | the principal force vector is typically |
| | | between 60°-120° or 240°-300° deg |
| | | degrees with 0 degrees representing |
| | | the front. |
| 70 | OCCUPANT | A human being within the vehicle 50 |
| | | who benefits from the protection of the |
| | | system 100. Occupants 70 include |
| | | both drivers 71 as well as passengers |
| | | 72. |
| 71 | Driver | An occupant 70 who is operating the |
| | | vehicle 50. |
| 72 | Passenger | An occupant 70 who is not operating |
| | | the vehicle 50. |
| 74 | Torso | The trunk of the occupant 70, i.e., the |
| | | human body of the occupant 70 |
| | | considered independently of the head |
| | | 88 and limbs. The torso 74 runs from |
| | | the shoulders down to the hips. The |
| | | torso 74 can be referenced in terms |
| | | of the H-Point 76 and torso angle 84. |
| 76 | H-Point | The mid-point of the hips or hip-femur |
| | | joint of the torso 74. The H-Point 76 |
| | | location as well as the movement of |
| | | the H-Point 76 can be described in |
| | | terms of three dimensions relative to |
| | | the vehicle 50 and seat assembly 200 |
| | | occupied by the occupant: (i) |
| | | horizontally forwards/backwards; (ii) |
| | | vertically upwards/downwards; and |
| | | (iii) laterally sideways. In the context |
| | | of a rear crash 62, the first two |
| | | dimensions are typically most |
| | | important. |
| 77 | Initial H-Point or H¹ | The H-Point 76 of the occupant 70 at |
| | | the point in time immediately prior to |
| | | the impact 60. |
| 78 | Post H-Point or H² | The H-Point 76 of the occupant 70 at |
| | | the point that varies as the occupant |
| | | 70 moves during the impact 60. |
| 80 | S-Point | The mid-point of the shoulders or |
| | | shoulder-arm joint of the torso 74. As |
| | | with the H-Point 76, the S-Point 80 |
| | | can be described in terms of |
| | | dimensions relative to the vehicle 50 |
| | | and seat assembly 200 occupied by |
| | | the occupant: (i) horizontally |
| | | forwards/backwards; (ii) vertically |
| | | upwards/downwards; and (iii) laterally |
| | | sideways. In the context of a rear |
| | | crash 62, the first two dimensions are |
| | | typically most important. |
| 81 | Initial S-Point or S¹ | The S-Point 80 of the occupant 70 at |
| | | the point in time immediately prior to |
| | | the impact 60. |
| 82 | Post S-Point or S² | The S-Point 80 of the occupant 70 that |
| | | varies as the occupant 70 moves in |
| | | the crash 60. |
| 84 | Torso Angle or α | The angle of the torso 74 in reference |
| | | to floor of the vehicle 50 from the front |
| | | to back of the vehicle. It is the angle of |
| | | a line between the H-point and S-point |
| | | rearward of vertical. |
| 85 | Initial Torso Angle or α¹ | The torso angle 84 of the occupant 70 |
| | | at the point in time immediately prior |
| | | to the impact 60. |
| 86 | Post Torso Angle or α² | The torso angle 84 of the occupant 70 |
| | | that varies as the occupant 70 moves |
| | | in the crash 60. |
| 87 | Critical Torso Angle or α^{C} | The torso angle 84 of the occupant 70 |
| | | that ramping starts up the seatback |
| | | 230 as the occupant 70 moves in the |
| | | crash 60. The system 100 can be |
| | | implemented with a variety of different |
| | | predefined threshold values for the |
| | | critical torso angle 87. |
| 88 | Head | The portions of the occupant 70 above |
| | | the torso 74. The head 88 includes |
| | | everything from the base of the neck |
| | | and up. |
| 89 | Leg(s) | The portions of the occupant 70 below |
| | | the torso 74. The legs 89 include |
| | | everything below the H-Point 76. |
| 91 | Undesirable or Unfavorable | A rear impact 62 to the vehicle 50 of |
| | Kinematics | the occupant 70 in which one or more |
| | | of the following typically occur: (a) H² > |
| | | H¹ in the vertical direction (b) α² >= |
| | | α^{C} with ramping 98. |
| 92 | Desirable or Favorable | A rear impact 62 to the vehicle 50 of |
| | Kinematics | the occupant in which typically none of |
| | | the following occur: (a) H² < H¹ in the |
| | | vertical direction (b) α² <= α^{C} without |
| | | ramping 98. |
| 93 | Load Area | A distribution or application of the |
| | | physical impact 60 to an area on |
| | | portion of the occupant 70. |
| 94 | Shoulder Belt Load | The load on the shoulder belt 340 |
| | | resulting from the impact 60. |
| 95 | Lap Belt Load | The load on the lap belt 350 resulting |
| | | from the impact 60. |
| 97 | Restrain or Restraint | The action of controlling, directing, |
| | | channeling, and/or limiting the |
| | | movement of an occupant 70 in the |
| | | event of an impact or crash 60. |
| 98 | Ramping | A movement of the occupant 70 in a |
| | | rear direction up the seatback 230 as |
| | | a result of rear impact 62. Movement |
| | | of the occupant 70 in which the |
| | | occupant 70 ramps or displaces up |
| | | the backrest 230. |
| 100 | PROTECTION SYSTEM | The system 100 in which the occupant |
| | | is protected during rear impacts 62 to |
| | | the vehicle 50. The system 100 is |
| | | used to avoid undesirable kinematics |
| | | 91. The protection system 100 can |
| | | include a variety of assemblies, |
| | | subassemblies, and components, |
| | | including the seat assembly 200 with |
| | | an anti-ramping guide 272 and/or a |
| | | seatbelt assembly 300 with a rear |
| | | pretensioner 305. |
| 110 | Crash Sensor or Sensor | A device within the vehicle 50 that |
| | | detects when the vehicle 50 is |
| | | experiencing a rear crash 62. There |
| | | are a wide variety of different sensors |
| | | 110 known in the prior art that are |
| | | suitable for use with the system 100. |
| | | The system 100 can also be |
| | | implemented with future technologies |
| | | of sensors 110 that perform the |
| | | functionality of detecting rear crashes |
| | | 62 even though such technologies do |
| | | not currently exist. Examples of |
| | | suitable sensor categories can include |
| | | but are not limited to mechanical |
| | | sensors, electrical sensors, and |
| | | optics-based sensors, such as an |
| | | airbag control module (ACM), EDR |
| | | (event data recorder) or crash |
| | | recorder. |
| 200 | SEAT ASSEMBLY OR SEAT | The assembly on which or in which the |
| | | occupant 70 sits. The seat 200 |
| | | typically includes a headrest 210, a |
| | | backrest 230, and a seat bottom 250. |
| | | Many embodiments also include a |
| | | side frame 270. Components within a |
| | | typical seat 200 can be modified to |
| | | avoid undesirable kinematics 91. |
| | | Components can be added to a typical |
| | | seat 200 to avoid undesirable |
| | | kinematics 91. A seat assembly 200 |
| | | typically includes a headrest |
| | | subassembly 210, a backrest |
| | | subassembly 230, a seat bottom |
| | | subassembly 250, and a side frame |
| | | subassembly 270. |
| 210 | Headrest Subassembly or | Portion of the seat 200 that supports |
| | Head Restraint | the head and neck of the occupant |
| | | 70. |
| 230 | Backrest Subassembly or | Portion of the seat 200 that primarily |
| | Seatback | constrains the horizontal movement |
| | | of the torso 74 of the occupant 70. |
| 232 | Recliner | Mechanism that allows adjustment in |
| | | the recline angle of the seatback. The |
| | | portion of the backrest 230 that |
| | | permits the adjustment of backrest |
| | | 230 so that the seat 200 can be put in |
| | | various degrees of reclined and |
| | | upright positions. |
| 234 | Raised Recliner | A recliner that is implemented in a |
| | | relatively elevated position to avoid |
| | | undesirable kinematics 91. |
| 235 | Cushion Frame | A component of the cushion support |
| | | 256 of the seat bottom 250 that mates |
| | | with the backrest 230. |
| 236 | Raised Cushion Frame | A cushion frame 235 that is |
| | | implemented in an elevated position |
| | | to avoid undesirable kinematics 91. |
| 250 | Seat Bottom Subassembly or | Portion of the seat 200 that primarily |
| | Cushion Subassembly | constraints the vertical movement of |
| | | the torso 74 of the occupant 70. |
| 256 | Cushion Support, Seat Pan, or | A structure that supports the seat |
| | Pan. | bottom 250. |
| 258 | Anti-Submarining Ramp | If there is a frontal impact after the |
| | | rear crash in a multi-impact collision, |
| | | the ramp prevents the undesirable |
| | | kinematics of moving the occupant |
| | | 70 forward and downward. |
| 260 | Release Brackets | Brackets that connect to the side |
| | | frames 270 and cushion support 356. |
| | | These brackets can be released |
| | | during a rear impact 62 from a variety |
| | | of potential triggering, including but |
| | | not limited to a pyrotechnic actuator |
| | | 262. |
| 262 | Pivot | The central point, axis, or shaft on |
| | | which a mechanism turns or |
| | | oscillates. The system 100 can be |
| | | implement with a pivot 262 to |
| | | maintain the anti-submarining ramp |
| | | 256 in position if there is a frontal |
| | | impact after the rear crash in a multi- |
| | | impact collision. |
| 270 | Side Frame Subassembly or | A portion of the seat 100 that forms |
| | Side Frame | the side of the seat cushion 256 and |
| | | connects the backrest 230 to the seat |
| | | bottom 250 by recliners 232. |
| 272 | Anti-Ramping Guide | A structure that channels the |
| | | movement of the occupant's 70 H- |
| | | Point 78 in a manner that avoids |
| | | ramping 98 and undesirable |
| | | kinematics 91 and promotes |
| | | desirable kinematics 92. The anti- |
| | | ramping guide 272 can include a |
| | | shell 274 and deformable brackets |
| | | 276 that secure the shell 274 within |
| | | the seat assembly 200. |
| 274 | Shell | A structural skeleton for the anti- |
| | | ramping guide 272 that is attached to |
| | | the side frame 270 by deformable |
| | | brackets 261. The shell 274 can be |
| | | adapted geometrically to support the |
| | | occupant 70 along the contour of the |
| | | back and bottom of the pelvis. The |
| | | deformable brackets attached to the |
| | | seat cushion frame |
| 275 | High-Back Shell | A shell that is implemented with a |
| | | relatively elevated rear shape to |
| | | avoid undesirable kinematics 91. |
| 276 | Deformable Brackets | Brackets connecting the anti-ramping |
| | | guide 272 to the side frame 270 of |
| | | the seat assembly 200 and deform |
| | | under controlled load. |
| 300 | SAFETY BELT ASSEMBLY | An assembly that includes one or |
| | OR SEAT BELT ASSEMBLY | more straps 301 that constrain the |
| | | movement and position of the |
| | | occupant 70 during an impact 60 to a |
| | | vehicle 50. The safety belt assembly |
| | | 300 typically includes a retractor 312, |
| | | shoulder belt 340 and a lap belt 350 |
| | | that can be secured and unsecured |
| | | around an occupant 70 through the |
| | | opening and closing of the latch 311. |
| 301 | Strap, Belt or Chord | A strip or chord of material used with |
| | | the safety belt assembly that moves |
| | | the anchor point to a position to |
| | | restrain 97 the occupant and provide |
| | | desirable kinematics 92 of the |
| | | occupant 70 in a rear impact. |
| 302 | Load Limiter | A mechanism that releases belt |
| | | webbing 319 when a force above a |
| | | threshold is applied to the safety belt |
| | | 300. It can be implemented as a fold |
| | | sewn into the belt webbing 319 that |
| | | tears. It is preferably implemented as |
| | | a torsion bar in the retractor |
| | | mechanism 312 that twist when |
| | | enough force is applied to it. The |
| | | torsion bar is secured to the locking |
| | | mechanism on one end and the |
| | | rotating spool on the other. In a less |
| | | severe accident, the torsion bar will |
| | | hold its shape, and the spool will lock |
| | | along with the locking mechanism. |
| | | But when a great deal of force is |
| | | applied to the webbing 310 (and |
| | | therefore the spool), the torsion bar |
| | | will twist slightly. This allows the |
| | | webbing 319 to extend out of the |
| | | retractor 312.. |
| 304 | Pretensioner | A mechanism that retracts some of |
| | | the webbing 319 of a belt 301 or |
| | | some other mechanism that moves |
| | | the anchor of the belt 301 when |
| | | triggered in an impact 60. This |
| | | results in tightening the belt 301 or |
| | | moving the anchor position of the belt |
| | | 301 to restrain the occupant 70. |
| 305 | Rear Pretensioner | A pretensioner 304 designed to |
| | | provide favorable kinematics 92 that |
| | | is triggered by a rear collision 62 and |
| | | provide occupant restraint 97 by the |
| | | lap belt 360. |
| 306 | Front Pretensioner | A pretensioner 304 designed to |
| | | provide favorable kinematics that is |
| | | triggered by a front collision 64. |
| 308 | Rotating Spindle | A mechanism that can tighten cables |
| | | 324 for both the shoulder belt 340 |
| | | and lap belt 350 with a single |
| | | pyrotechnic actuator 306. |
| 310 | Buckle | A frame with a hinged pin that mates |
| | | with latch 311 to secure the belt 301 |
| | | in a closed position. |
| 311 | Latch | A bar with a catch and lever or lock |
| | | used to secure the belt 301 in a |
| | | closed position. |
| 312 | Retractor | A mechanism with a spindle that |
| | | winds in and unwinds out seatbelt |
| | | webbing 319. The spindle |
| | | automatically locks in a crash. A |
| | | retractor 312 prevents a belt 301 |
| | | from further extension while a |
| | | pretensioner 304 actually pulls in on |
| | | the belt 301. |
| 314 | Cable | A flexible connector between the |
| | | anchor 316 and the belts 301 of the |
| | | seat belt assembly 300. |
| 315 | Anchor Bracket | A structure connecting the belt 301 to |
| | | the anchor 316. |
| 316 | Anchor | A location on the vehicle 70 to which |
| | | the seat belt assembly 300 is secured |
| | | and based. Typically connected to the |
| | | seat bottom 250 to which the seat belt |
| | | 300 is based or attached |
| 317 | Anchor¹ | The position of the anchor 316 of the |
| | | occupant 70 at the point in time |
| | | immediately prior to the impact 60. |
| 318 | Anchor² | The position of the anchor 316 after |
| | | dynamically being moved to a |
| | | different location once a rear crash |
| | | 62 is detected and a rear |
| | | pretensioner 305 is activated. |
| 318 | Webbing | The portion of a belt 301 that is |
| | | pulled around the occupant 70. It is |
| | | tightened by the retractor 312 during |
| | | an impact 60. |
| 320 | Actuator | A device that starts the functionality of |
| | | the system 100 after a sensor 110 |
| | | detects a crash 60 and triggers the |
| | | actuator. The actuator 320 is what |
| | | starts or activates the rear |
| | | pretensioner 305 in response to |
| | | sensing a rear impact 62 above a |
| | | threshold severity and triggering the |
| | | actuator. |
| 322 | Pyrotechnic Actuator | A category of pretensioners 304 that |
| | | trigger pyrotechnics in response to a |
| | | rear impact 62. |
| 324 | Buckle Pretension Actuator | Pyrotechnic designs that pull a cable |
| | | 314 attached to the seatbelt 300 latch |
| | | 311, buckle 310 or anchor 317when a |
| | | crash is detected |
| 340 | Shoulder Belt Assembly | A safety belt 300 positioned over the |
| | | shoulder of the torso 74 of the |
| | | occupant 70 |
| 350 | Lap Belt Subassembly or Lap | A belt 301 positioned across to the |
| | Belt | lap or lap of the occupant 70. |
| 360 | Wrap Around Lap Belt | An additional belt 310 added to a lap |
| | | belt assembly 350. It provides an |
| | | added loop of webbing 319 behind |
| | | the occupant 70 to further restrain the |
| | | occupant 70 from a rear impact 62. |
| 900 | METHOD | A process for protecting an occupant |
| | | 70 in a vehicle 50 from a rear collision |
| | | 62. |

### III. OCCUPANT KINEMATICS IN A REAR COLLISION

It is helpful to first understand the undesirable kinematics 91 to an occupant 70 that could otherwise result from a rear impact 62 to a vehicle 50 when the system 100 is not present in order to then understand the manner in which the system 100 can direct the movement of an occupant 70 towards desirable kinematics 92.

A. Rear Crashes and Directional Frame of Reference

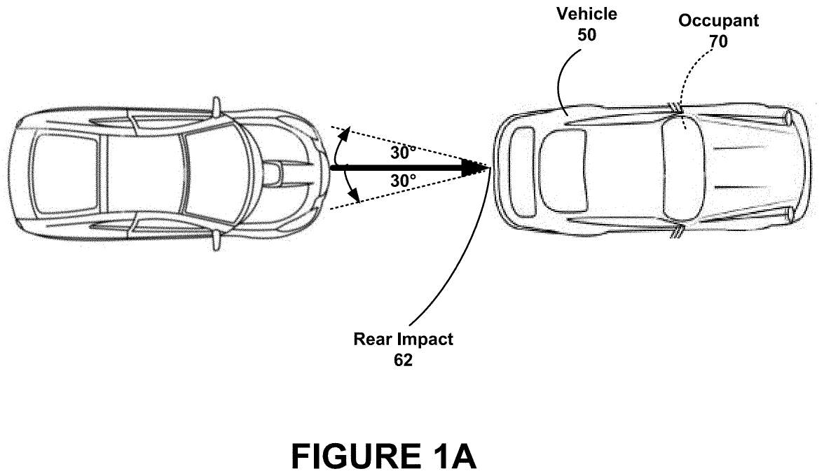

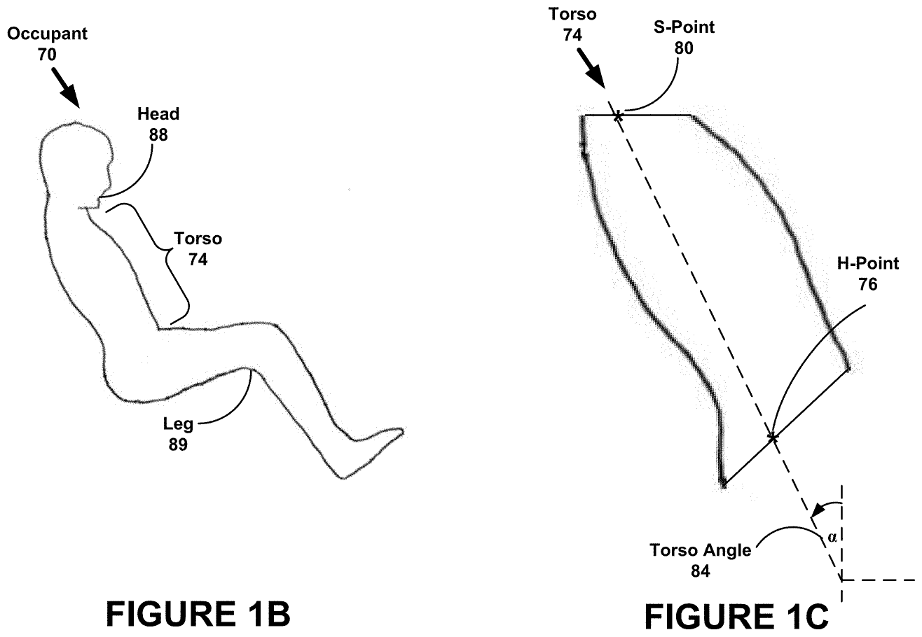

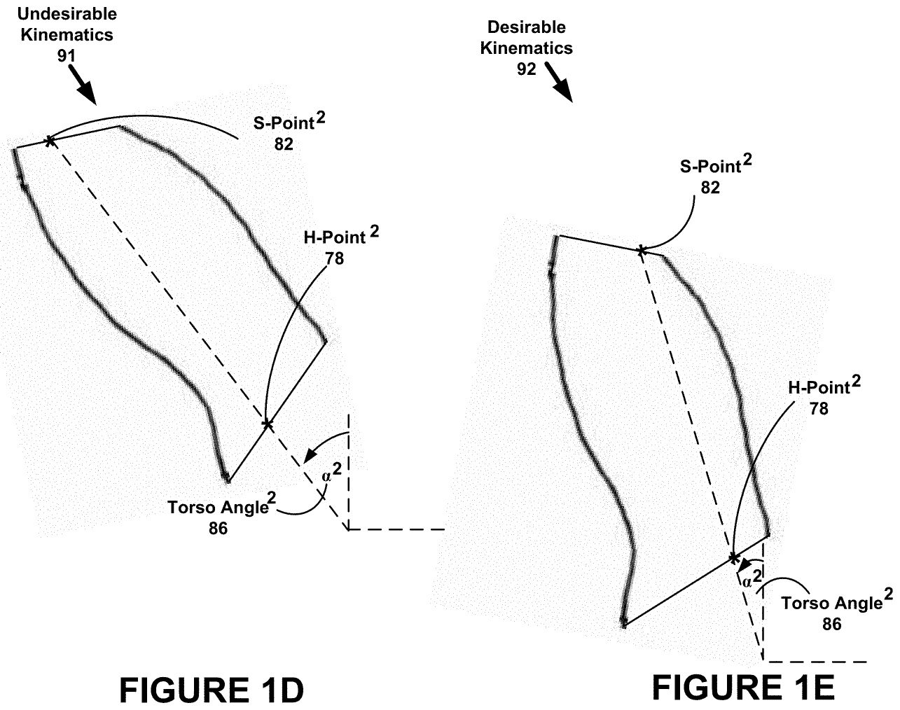

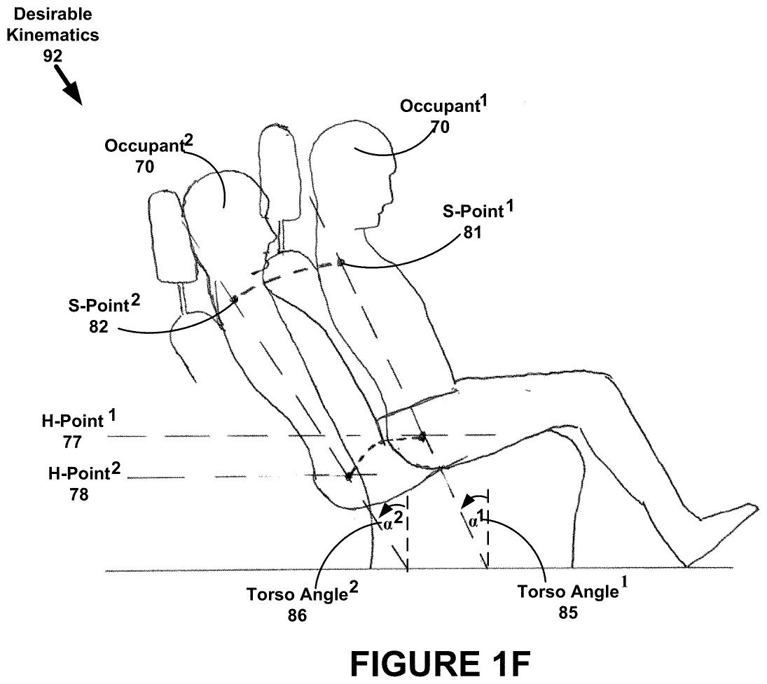

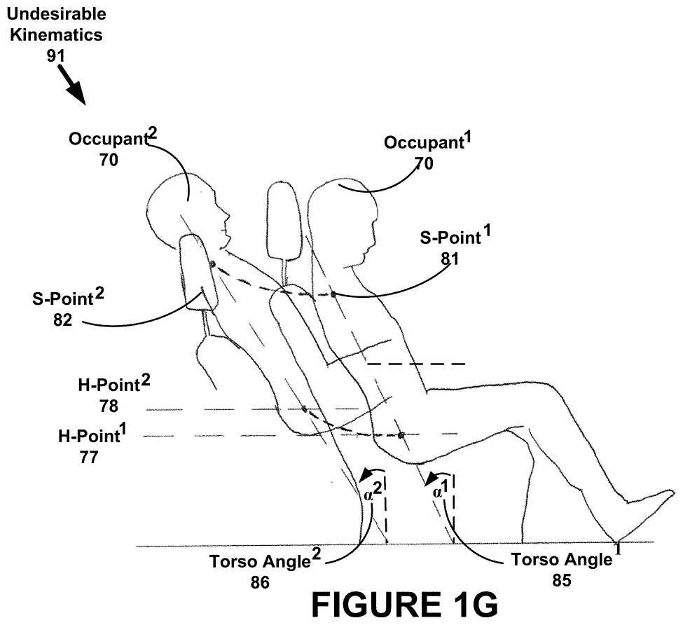

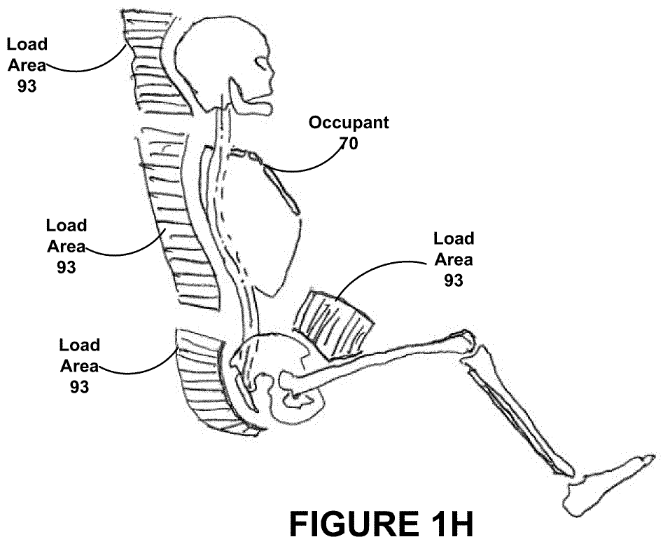

FIG. 1A is diagram illustrating an example of a top view of rear crash 62 between two vehicles 50. With a dead-on front crash 64 being at 0° and a dead-on rear crash being at 180°, a rear crash 62 is any crash 60 from 150° to 210°.

In describing the position of the occupant 70 as well as the directional movement of the occupant 70, the frame of reference used to describe the system 100 is the frame of reference of an occupant 70 seated the seat assembly 200 and facing the dashboard of the vehicle 50. The “forward” direction is towards the windshield and front of the vehicle 50, with the “rear” direction being towards the back of the vehicle 50. The “right” and “left” directions are from the perspective of a driver 71 or passenger 72 facing towards the front of the vehicle 50. An “upwards” direction is towards the roof of the vehicle 50 and a “downwards” direction is towards the floor of the vehicle 50. The forward and rear direction is referred to as the X-axis, the upward and downward direction is referred to as the Z-axis, and the right and left direction is referred to as the Y-axis.

B. Occupant Torso

FIG. 1B is a diagram illustrating an example of a side view of occupant 70 in a seated position within a vehicle 50. A typical human occupant 70 will have a head 88 a torso 74, and appendages such as legs 89 and arms. In the context of the kinematics of a crash 60 it is the position and motion of the torso 74 that typically constitutes the key differentiator between undesirable kinematics 91 and desirable kinematics 92, as it is the torso 74 that is the center of gravity of the occupant 70 and the relative movements of the arms and legs of the human body are not specifically addressed in the context of a crash 60.

FIG. 1C is a diagram illustrating an example of a side view of a torso 74 of an occupant 70. The diagram illustrates several reference points and other metrics that are helpful in describing the motion of an occupant 70 during a rear crash 62. Such metrics include an S-Point 80, which is the mid-point of the shoulders, the H-Point 76, which is the middle of the hips and the torso angle α 84, which is the angle formed by the intersection of the vertical plane and the plane defined by the H-Point 76 and S-Point 80. These parameters are illustrated in FIGS. 1C and 1D and defined and described in greater detail in the Glossary of Terms provided in Table 1 above.

The nomenclature of H-Point 76, S-Point 80, and torso angle α 84 are used to represent those elements generally. A superscript notation of “1” (H-Point¹ 77, S-Point¹ 81, and torso angle α¹ 85) is used to represent those parameters immediately prior a rear impact 62 to the vehicle 50 (collectively, “pre-crash parameters”). A superscript notation of “2” (H-Point² 78, S-Point² 82, and torso angle α² 86) is used to represent those parameters during a rear impact (collectively, “crash parameters”). The changes from pre-crash parameters to crash parameters are what make the difference between undesirable kinematics 91 and desirable kinematics 92.

C. Undesirable Kinematics Vs. Desirable Kinematics

FIG. 1D is a diagram illustrating an example of a side view of a torso 74 experiencing undesirable kinematics 91 during a rear collision 62. This is the torso 74 as it would look ramping backwards and upwards as a result of a rear collision 62.

FIG. 1E is a diagram illustrating an example of a side view of a torso 73 experiencing desirable kinematics 92 during a rear collision 62. In comparison to FIG. 1D, the torso 73 in FIG. 1E is more upright and the H-point would be lower than in FIG. 1D.

FIG. 1F is a diagram illustrating an example of a side view of an occupant experiencing desirable kinematics 92 while moving within a vehicle during a rear collision 62. FIG. 1F illustrates both pre-crash parameters and crash parameters. H-Point² 78 is vertically lower than H-Point¹ 77, S-Point² 82 is vertically lower than S-Point¹ 81 and the Torso Angle α² 86 is greater than Torso Angle α¹ 85, but not so great as to cause ramping. FIG. 1F shows desirable kinematics 92 with the occupant 79 deforming the seatback 230 and with a rearward and downward trajectory of the H-point 76 and S-point 80. This keeps the head 88, neck and torso 74 against the seatback 230 and head restraint 210 without ramping 98. The hip and shoulder of the occupant 70 move along an arc rearward and downward. The kinematics are desirable kinematics 92 because they prevent the mechanisms of injury with a portion of the occupant's body losing support from the seatback 230 and head restraint 210 with ramping 98. Ramping 98 increases the height of the occupant 70 on the seatback 230 and increases the moment arm of the occupant 70 loading on the seatback 230. This increases the deformation of the seat assembly 200.

FIG. 1G is a diagram illustrating an example of a side view of an occupant 70 experiencing undesirable kinematics 91 while moving within a vehicle 50 during a rear collision 62. FIG. 1G illustrates both pre-crash parameters and crash parameters. H-Point² 78 is vertically higher than H-Point¹ 77, S-Point² 82 is vertically higher than S-Point¹ 81 and the Torso Angle α² 86 is smaller than Torso Angle α¹ 85. FIG. 1G illustrates unfavorable occupant kinematics 91 evidenced by the ramping 98 of the occupant 70 up the seatback 230. This increases the relative height of the occupant 70 with respect to the seatback 230 and head restraint 210 and increases the tendency to lose support of the body by the seat 200. The ramping 98 causes the shoulders of the occupant 70 to load the bottom of the head restraint 210 pushing it up against the stops at the highest position of adjustability.

Unfavorable kinematics in rear impact seen in FIG. 1G right involved a risk for injury to the cervical or thoracic spine (C-spine or T-spine) by the head or upper body hyper-extending rearward around the frame of the seatback causing fracture-dislocation of the cervical or thoracic spine. (Viano D C. Fracture-Dislocation of the Thoracic Spine in Extension with Upright Seats in Severe Rear Crashes. SAE 2011-01-0274, Society of Automotive Engineers, Warrendale Pa., 2011). With sufficiently severe crash forces and/or occupant weight, the seatback rotation and ramping may involve occupant impact in the rear interior with possible injury to the cervical and/or thoracic spine by a diving mechanism.

Induced ramping occurs in some accidents. It is not caused by the occupant sliding up the seatback, but by other dynamics in rear impacts. It can be caused by over-ride of the rear of the struck vehicle, where the seat is pushed down away from the seated occupant held in space by inertia. (Parenteau C, Croteau J, Zolock J. The Effect of Crash Severity and Structural Intrusion on ATD Responses in Rear-End Crashes. SAE 2020-01-1224, Society of Automotive Engineers, Warrendale, Pa., 2020). There is a second means to induce ramping by the rear of the seat cushion squatting down early in the occupant loading. The squatting is related to the downward force on the rear attachments of the seat to the floor. With sufficient force, components in the seat deform in ways not seen in FMVSS 207-type testing. The speed of over-ride and squatting induces ramping with inertia holding the position of the hip suspended in space as the seat drops.

FIG. 1G shows motion sequence criteria for rear impacts 62. The motion sequence criteria for favorable kinematics in a rear impact are based on the trajectory of the H-point (center of the hip) and torso angle (α), which is defined as the angle between the H-point and S-point, center of the shoulders. The proposed criteria are: (1) the H-point moves rearward up to a maximum of typically 125-200 mm with a downward trajectory of up to a maximum of typically 20-50 mm; and (2) the torso angle rotates rearward from the initial design position of 105-120 deg to up to a maximum of typically 140-155 deg at maximum restraint but below the critical angle, typically between about 40 degrees and 60 degrees, but varying with the seat design. The point of maximum restraint and the critical torso angle for ramping depend on the severity of the crash, size of the occupant and strength and design of the seat. The optimum trajectory for the anti-ram ping guide depends on seat strength and design. It varies from the trajectory shown in FIG. 1G to essentially only downward movement. Occupants that are out of position at the start of impact are not covered by the criteria.

The motion sequence criteria for rear impact complement the control of biomechanical responses compared to tolerances to provide an assessment of restraint performance. The occupant kinematics shown in FIG. 1G are consistent with the favorable motion of the H-point and S-point. However, sled tests show a tendency for ramping up the seatback and essentially no restraint from the seatbelt in severities up to 48 km/h (25 mph) with and without buckle or retractor pretensioning with modern seats. (Viano D C, Parenteau C S, Burnett R. Influence of Belt Pretensioning on Dummy Responses in 40 km/h Rear Impact Sled Tests. Traffic Injury Prevention, 13(1):65-71, 2012; Viano D C, Burnett R, Miller G A, Parenteau C S. Influence of Retractor and Anchor Pretensioning on Dummy Responses in 40 km/h Rear Sled Tests. Traffic Injury Prevention, 22:5, 396-400, 2021). The sled testing shows that occupant pocketing and seatback rotation occur simultaneously and the amount of either is a factor depending on the seat design.

FIG. 1H is a diagram illustrating an example of a side view of an occupant 70 and the load areas 93 on the occupant 70 during a rear collision 62 in which the system 100 is used to achieve desirable kinematics 92. The load areas 93 are disbursed across the seat assembly 200 and belt assembly 300 and primarily load the boney structures of body 70 with forces equally distributed on the spine and without a concentration of force on one area of the spine.

FIG. 1H shows favorable loading of the occupant by the seat and lap belt in rear impacts without ramping. The anti-ramping guide and rear pretensioner provide load on the pelvis and thighs that couple the occupant to the seat cushion frame. This avoids the forces of ramping up the seatback. The rear pretensioner loads the lap belt on both sides of the hip and thighs helping guide the H-point as the hip displaces rearward and downward maintaining load from the head on the head restraint and torso on the seatback. The rear pretensioner avoids the negative effects of induced ramping by force in the lap belt holding the occupant on the seat. Ramping increases the moment arm of the force of the occupant loading the seatback and increase deformation of the seatback.

### IV. INTRODUCTION OF ASSEMBLIES AND COMPONENTS

A vehicle 50 utilizing the system 100 can use a variety of different assemblies, subassemblies, components, and configurations to avoid undesirable kinematics 91. The system 100 can utilize: (a) an anti-ramping guide 272 in the seat assembly 200; (b) a rear-pretensioner 305 within the belt assembly 300; or (c) a configuration of both the anti-ramping guide 272 and the rear-pretensioner 305. The system 100 can also utilize additional related, supplemental, and supportive components.

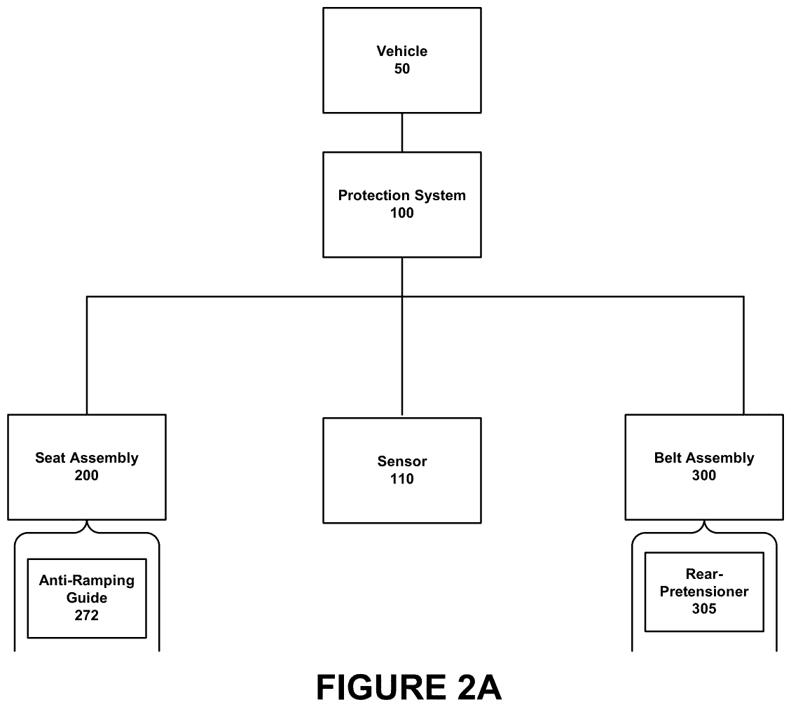

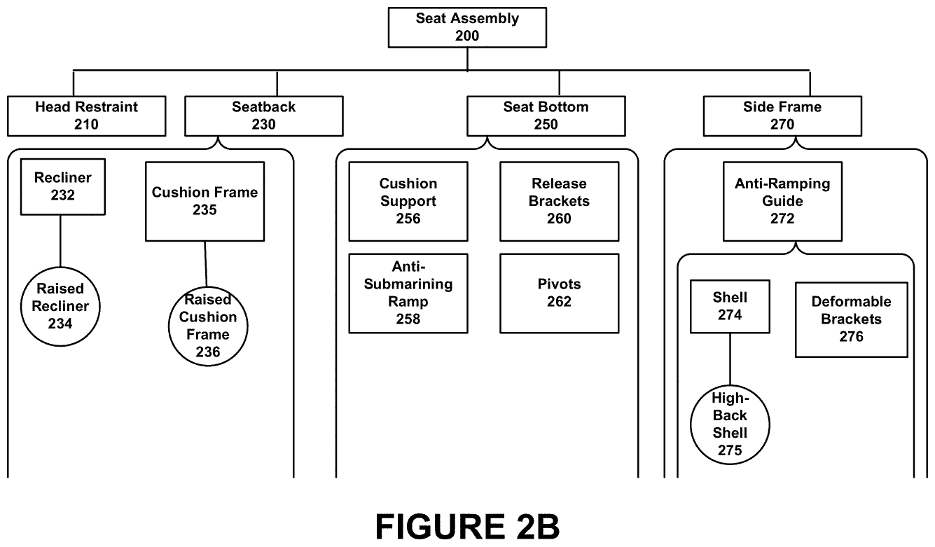

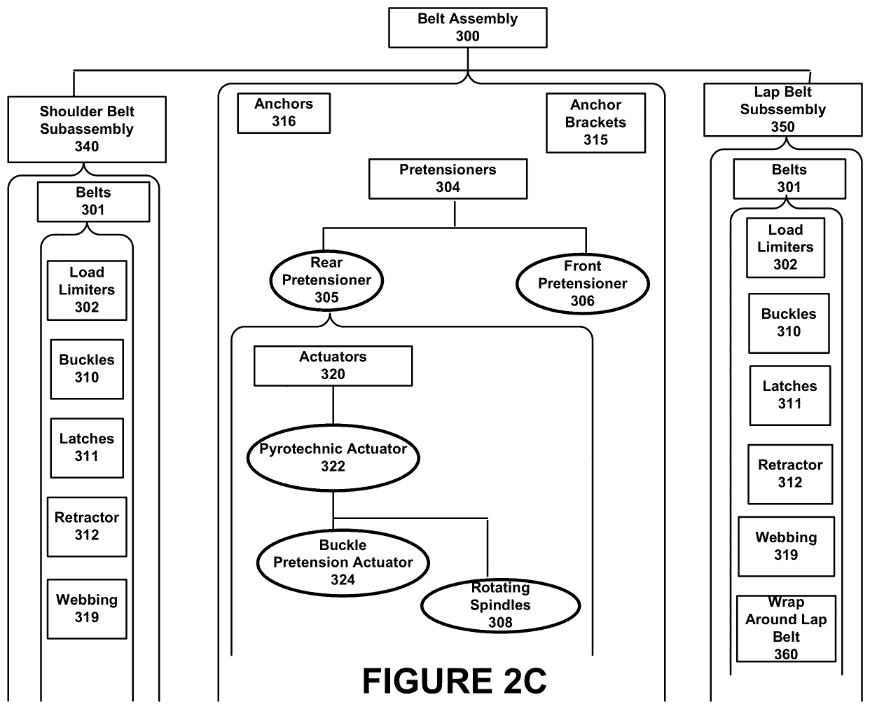

FIG. 2A is a block diagram of a system 100 that includes a seat assembly 200 with an anti-ramping guide 272 and/or a belt assembly 300 with a rear-pretensioner 305. Either configuration can also utilize one or more sensors 110 to detect a rear impact 62 that can start the operation of the system 100.

A. Seat Assembly

The seat assembly 200 can include a variety of subassemblies, components, and configurations that relate to the functionality of the system 100 avoiding undesirable kinematics 91 in the context of rear end collisions 62. As illustrated in FIG. 2B and as listed in the Glossary of Terms provided in Table 1, the subassemblies of the seat assembly 200 can include the head restraint 210, the seatback 230, the seat bottom 250, and the side frame 270. The seatback 230 can include raised recliners 234 and raised cushion frames 236. The seat bottom subassembly 250 can include cushion supports 256, release brackets 260, and an anti-submarining ramp 258 for protecting occupants 70 in the context of front impacts 64. The side frame 270 can include anti-ramping guides 272, shells 274, high-back shells 275, and deformable brackets 276.

Desirable kinematics 92 can be achieved over a wider range of rear impact 62 situations by the use of an anti-ramping guide 272 in the seat cushion that directs the hip into a rearward and downward trajectory. The anti-ramping guide 272 can be comprised of a shell 274 or a high-back shell 265 contoured to the back and bottom of the pelvis and deformable brackets 276 attaching the shell to the cushion frame 236. The brackets 276 are designed to displace along a rearward and downward trajectory shown by bending of the deformable brackets 276 attached to the seat cushion frame 236 or other suitable means.

The anti-ramping guide 272 can be used independently of the rear pretensioner 305, but there are advantages to incorporating both into the system 100. Moreover, the protective function of the seat assembly 200 can be further enhanced by using a high-back shell 270 as the shell 274, a raised recliner 234 as the recliner 232, a raised cushion frame 236 as the cushion frame 235, or by lowering the cushion support 256 (which can also be referred to as the “pan”) by releasing the release brackets 260 during a rear crash 62.

B. Belt Assembly

The belt assembly 300 can include a variety of subassemblies, components, and configurations that relate to the functionality of the system 100 avoiding undesirable kinematics 91 in the context of rear end collisions 62. As illustrated in FIG. 2C and as listed in the Glossary of Terms provided in Table 1, the subassemblies of the belt assembly 300 can include the shoulder belt subassembly 320 and the lap belt subassembly 350. The belt assembly 300 can include belts 301, load limiters 302, buckles 310, latches 311, and retractors 312. A variety of sensors 110 can be used to trigger the actuators 320 for a response by the system 100 to a rear impact, such as pyrotechnic actuators 307, buckle pretension actuators 309, spindle actuators or other suitable means. Some embodiments of the belt assembly 300 can use rotating spindles 308. The belt assembly 300 can use those actuators to move anchors 316 where the belts 301 are connected to a more favorable location to achieve desirable kinematics and restraint of the rearward movement of the occupant 70. Some embodiments of the anchors 306 can use anchor brackets 315.

The rear pretensioner 305 for the lap belt 301 can enhances the coupling of the hip to anti-ramping guide 272 to ensure desirable kinematics 92 in a rear impact 62. The rear pretensioner 305 can pull the inboard and outboard lap belt 301 downward and forward to shorten the arc of its rearward rotation creating new anchor 306 locations. The shorter arc causes the lap belt to load the hip and to provide restraining forces on the occupant 70. This can pull the hip of the occupant down into the shell of the anti-ramping guide causing the hip to displace in a controlled trajectory rearward and downward in a crash.

The rear pretensioner 305 can be used independently of the anti-ramping guide 272, but there are advantages to incorporating both into the system 100.

### V. SEAT ASSEMBLY—DETAILED DESCRIPTION

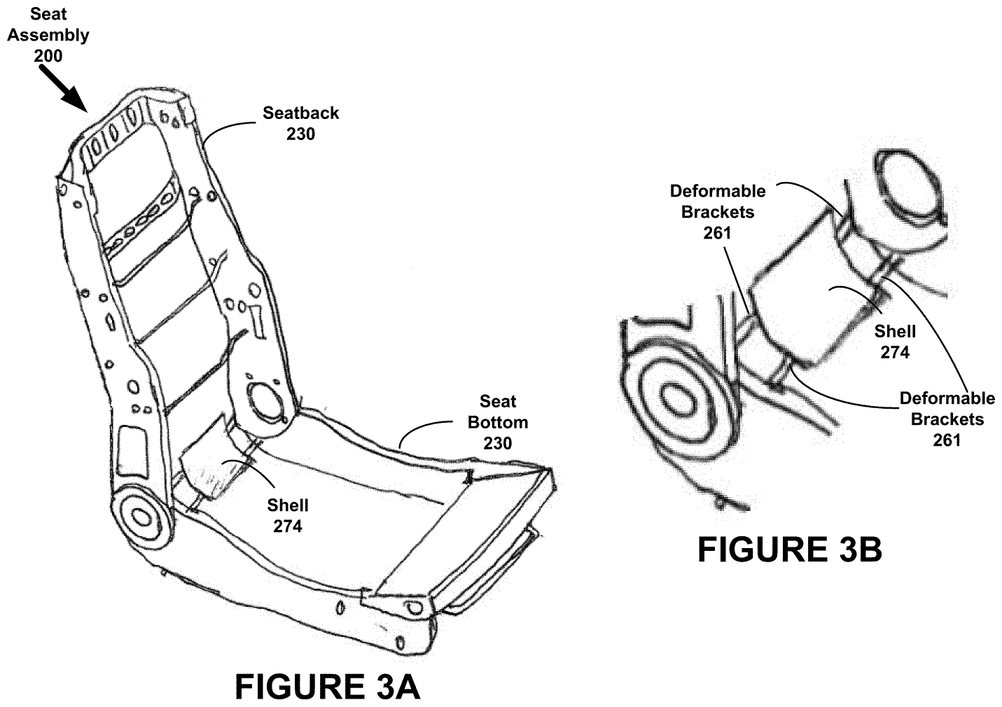

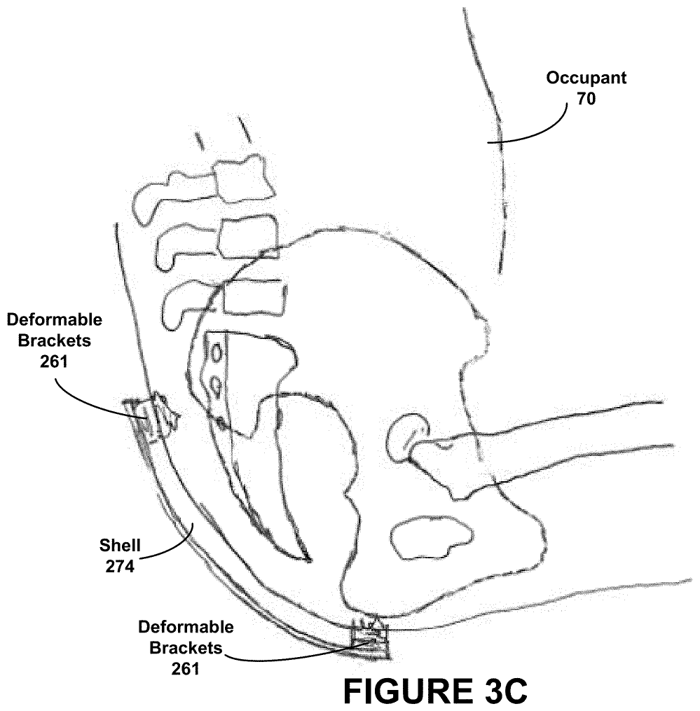

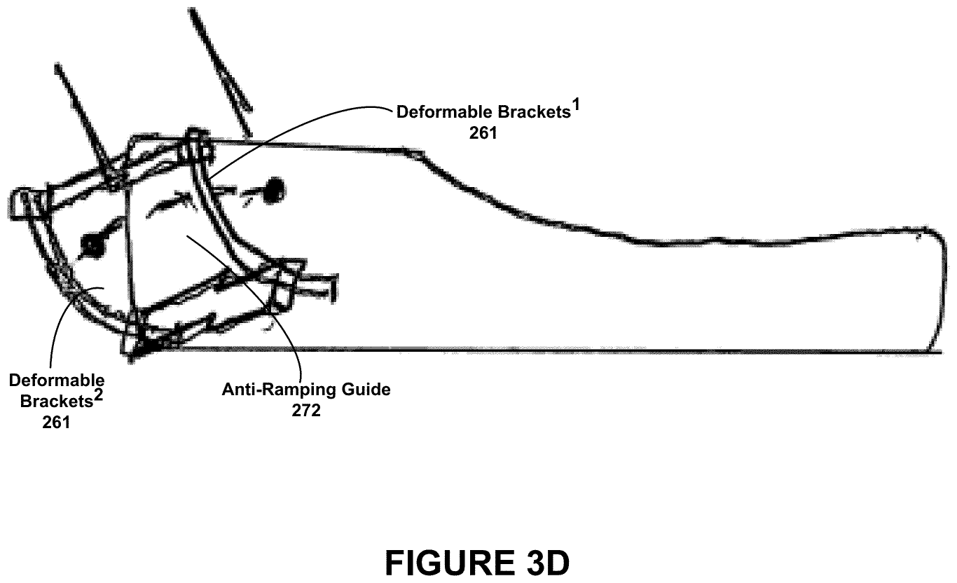

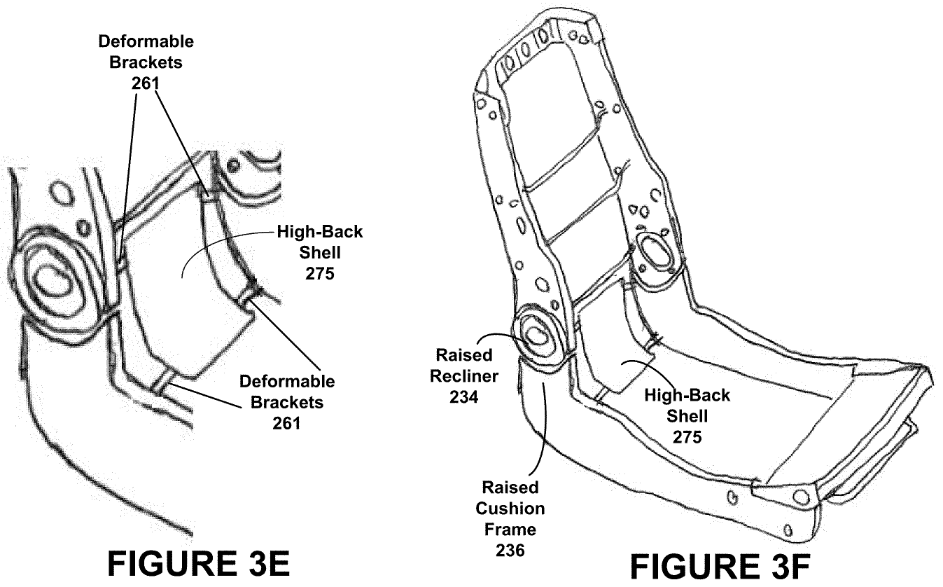

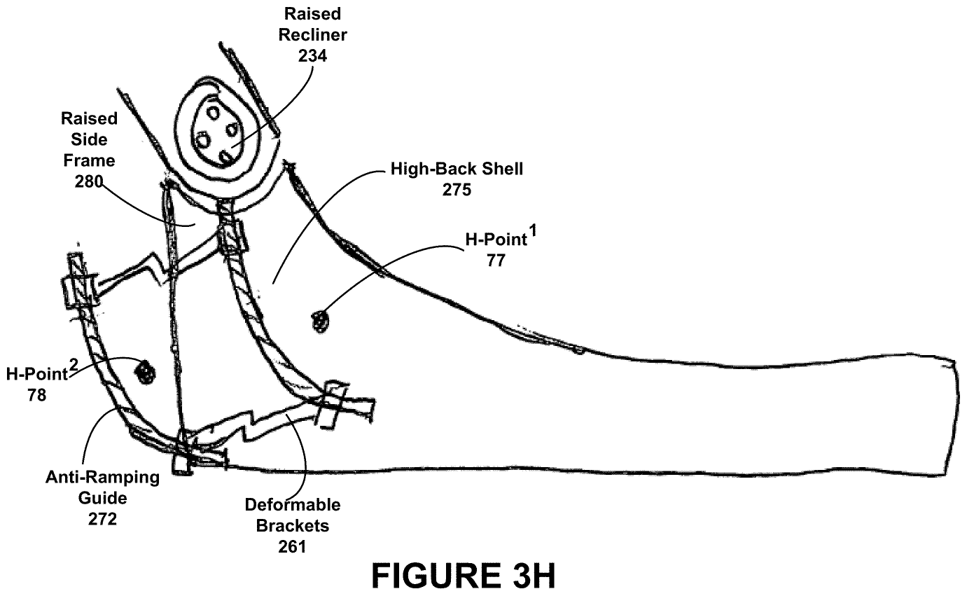

FIG. 3A is a diagram illustrating an example of a perspective view of a seat assembly 200 with an anti-ramping guide 272 comprised of a shell 274 with deformable brackets 261 that are mated to a seat bottom 230 and cushion frame 235. FIG. 3B is a close-up view of the deformable brackets and shell of the seat assembly in FIG. 3A.

The two figures show the anti-ramping guide 272 in the rear of the seat cushion frame 235. It supports the ischial tuberosities and sacrum of the seated occupant 70. It is attached to the cushion frame 235 by deformable brackets 276 that bend in a manner that guides the hip rearward and downward in a rear impact. The amount of rearward and downward motion depends on the seat design. There is a family of trajectories possible from mostly down with minimal rearward displacement to down with greater rearward displacement to provide energy absorption.

A purpose of the anti-ramping guide 272 is to provide restraint of the occupant 70 by a load-path into the seat cushion frame 235. This reduces the forces on the seatback and reduces the loads supported by the recliners 232. This is beneficial in lowering the deformation of the seatback, allowing the seatback to remain more upright in a rear impact than with conventional seat designs of similar strength.

FIG. 3C is a side view diagram illustrating an example of an occupant 70 positioned relative to the deformable brackets 276 and shell 274 of the seat assembly 200. The figure shows a skeletal profile of a seated occupant's hip with the shell 274 of the anti-ramping guide 272 wrapping around the rear and bottom of the bony structures of the pelvis. It shows the deformable brackets 276 connected to the seat cushion frame 235.

The shows a side view of the anti-ramping guide 272 in the initial and deployed position. Movement of the anti-ramping guide 272 under load directs the H-point 76 rearward and downward by deformation of brackets 276 attached to the cushion frame 235. The image shows the initial and deformed positions. The force-deflection characteristics of the brackets 276 involve a threshold force to start the bending of the brackets and a target maximum force at full deployment. Nominally, the bracket 276 starts bending in a 24-32 km/h (15-20 mph) ΔV crash with a 50^{th} Hybrid III dummy and is fully deployed in a 48-56 km/h (30-35 mph) ΔV crash. The actual details require determination during development of a vehicle application.

FIG. 3D is a side view diagram illustrating an example of the deployment of an anti-ramping guide 272 during a rear-end collision 62. FIG. 3D shows a side view of the anti-ramping guide 272 in the initial and then deployed position. Movement of the anti-ramping guide 272 under load directs the H-point 76 rearward and downward by deformation of brackets 276 attached to the cushion frame 235. The image shows the initial and deformed positions. The force-deflection characteristics of the brackets 276 involve a threshold force to start the bending of the brackets 276 and a target maximum force at full deployment. Nominally, the bracket 276 starts bending in a 24-32 km/h (15-20 mph) ΔV crash with a 50^{th} Hybrid III dummy and is fully deployed in a 48-56 km/h (30-35 mph) delta V crash. The actual details require determination during development of the specific application for the vehicle 50.

FIG. 3E is a diagram that resembles FIG. 3B except that it illustrates an example of a high-back shell 275 as an alternative to the shell 274 of FIG. 3B. FIG. 3F is a diagram that resembles FIG. 3A except that it illustrates an example of a high-back shell 275 as an alternative to the shell 274 of FIG. 3A. The figures show a high-back anti-ramping guide 272 that is attached to a cushion frame 236 with raised rear side members. This raises the recliners on the inboard and outboard side and shortens the bottom edge of the seatback frame. The high-back anti-ramping guide provides greater support for the back of the pelvis.

The orientation of the back of the shell 274 is typically more vertical than the normal recline of the seat in the design position. The more vertical orientation of the back of the shell 274 reduces the tendency for the pelvis to slide up or ramp up an inclined slope.

FIG. 3G is a diagram that resembles FIG. 3D except that it illustrates an example a high-back shell 275 as an alternative to the shell 274 of FIG. 3D. FIG. 3G shows a skeletal profile of a seated occupant's hip with a high-back shell 275 of the anti-ramping guide 272 wrapping around higher on the rear of the bony structures of the pelvis. It shows the deformable brackets 276 connected to the raised cushion frame 236. The high-back shell 275 supports the ischial tuberosities, sacrum and may extend up into the lumbar spine of the seated occupant 70. The high-back shell 275 is attached to the cushion frame 236 by deformable brackets 276 that bend in a manner that guides the hip in a set trajectory rearward and downward in a rear impact 62.

FIG. 3H is a diagram that resembles FIG. 3D except that it illustrates an example a high-back shell 275 as an alternative to the shell 274 of FIG. 3D. FIG. 3H shows a side view of the high-back anti-ramping guide 272 with deformable brackets 276 attached to a raised side of the cushion frame 236. This raises the recliners 234 and height of the back surface of the shell 275 to provide more support for the pelvis and a load path to the cushion frame 236 with restraint forces in a rear impact 62.

Another embodiment is for seats with cushion structures 256 (which can be referred to as “cushion supports”) supporting the occupant's pelvis on foam and spring suspensions. The cushion structure 256 may be sufficiently stiff to support the occupant 70 in normal use of the seat that it prevents the pelvis from dropping and deforming the anti-ramping guide 272 in the manner intended. Dynamic release of the central structures of the cushion support 256 is achieved by pyrotechnic actuation 322 of release brackets 260 in rear impacts above a threshold ΔV. The release bracket 260 connects the central cushion support 256 structures to the side frames of the seat cushion.

FIG. 3I is a perspective diagram illustrating an example of a seat assembly 200 with release brackets 260 and pivots 262. FIG. 31 shows the central seat cushion support 256 connected to the side frames by release brackets 260. In rear impacts 62 above the threshold ΔV, the brackets release the connection to the side frames 270 at the rear allowing the pelvis support for normal use of the seat to drop and allowing the pelvis to load and deform the anti-ramping guide 272 by pivoting at the front of the seat cushion.

### VI. BELT ASSEMBLY—DETAILED DESCRIPTION

Prior art seat belt technology is designed to addresses front impacts, but do not provide early restraint in rear impacts. The use of rear pretensioners 305 to move the anchors 316 connecting the belts 301 to the vehicle 50 can provide early occupant 70 restraint.

A. Research and Test Data

Seatbelts 301 were pretensioned in rear crashes starting with the 1997 Saab 9-5 and 9-3 with the introduction of an active head restraint in a high retention seat. (Viano D C, Olsen S. The Effectiveness of Active Heads Restraint in Preventing Whiplash. Journal of Trauma, 51(5):959-969, 2001; Viano D C, Role of the Seat in Rear Crash Safety. SAE Book, ISBN 0-7680-0847-6, Society of Automotive Engineers, Warrendale, Pa., SAE R-317:1-491, 2002). The pretensioner 394 was activated in crashes above 24 km/h (15 mph) delta V (change in velocity) to remove slack in the belt system. Its activation was based on the logic that pretensioning could “do no harm” in such crashes and it might offer safety benefits in a severe rear impact 62. The Saab pretensioner was a retractor design that tightened the shoulder belt by reeling shoulder belt webbing into the retractor. This tightened the lap belt by pulling webbing through the sliding latch plate.

High retention seats have an open, perimeter seatback frame and a low-profile cushion frame allowing the occupant to pocket into the seatback in a rear impact. Background on the high retention seats can be found in Viano D C, Role of the Seat in Rear Crash Safety. SAE Book, ISBN 0-7680-0847-6, Society of Automotive Engineers, Warrendale, Pa., SAE R-317:1-491, 2002; Viano D C, Editor. The Debate Between Stiff and Yielding Seats: A New Generation of Yielding Seats with High Retention in Rear Crashes. SAE Book PT-106, Society of Automotive Engineers, Warrendale Pa., 2003; and Viano D C. Seat Design Principles to Reduce Neck Injuries in Rear Impacts. Traffic Injury Prevention 9(6): 552-560, 2008. In a rear impact, the open perimeter frame and low profile allow the pelvis to displace rearward and downward by clearing away obstructions that might cause the hip to rise. (Viano D C, Role of the Seat in Rear Crash Safety. SAE Book, ISBN 0-7680-0847-6, Society of Automotive Engineers, Warrendale, Pa., SAE R-317:1-491, 2002). The use of cross-tubes between the inboard and outboard recliner places a structure behind the pelvis. The rods can bend rearward by hip loading. In some designs, a shield has been added to prevent cross-tube bending, but the shield is stiff and promotes pelvic lift in a rear impact.

There is a mix of automotive manufacturers that either do or do not trigger pretensioners in rear impacts. (Edwards M A, Brumbelow M L, Trempel R E, Gorjanc T C. Seat Design Characteristics Affecting Occupant Safety in Low- and High-Severity Rear-Impact Collisions. IRC-19-11, IRCOBI conference, 2019). The pretensioner 304 is either a retractor design that back-winds webbing on the spool of the retractor, similar to the one used in the Saab 9-5 and Saab 9-3, or a buckle design that pulls down on the latch plate tightening the lap and shoulder belts on the inboard side of the seat. Laboratory tests on the effect of pretensioning in rear impacts show a consistent result. Pretensioning has no effect in testing up to 48 km/h (25 mph) delta V.

Currently, the are no pretensioners 304 designed specifically for rear impacts 62 and automotive seats do not have something akin to the anti-submarining ramp 258 for frontal crashes to support and control the motion of the pelvis in rear impacts 62.

Rear Impact Dynamics: In rear impacts 62, the occupant moves rearward relative to the interior and away from the seatbelts 301. The shoulder belt 340 becomes unloaded. The lap belt 350 moves in an arc from forward around the pelvis to rearward as the occupant pockets into the seatback. (Viano D C, Parenteau C S, Burnett R, Prasad P. Occupant Responses in Conventional and ABTS Seats in High-Speed Rear Sled Tests with a Normally Seated Dummy. Traffic Injury Prevention, 2; 19(1):54-59, 2018). The amount of rearward movement depends on the initial posture and size of the occupant and compliance of the seat for a given crash severity. The thighs normally rise up at the knees with occupant loading into the seatback in a rear crash. The legs rising “trap” the lap belt on the pelvis or lap. (James M B, Strother C E, Warner C Y, Decker R L, Perl T R. Occupant protection in rear-end collisions: I. Safety priorities and seat belt effectiveness. 35th Stapp Car Crash Conference, SAE 912913, Society of Automotive Engineers, Warrendale, Pa., 1991; Petit P, Luet C, Potier P, Vallancien G. Investigation on occupant ejection in high severity rear impact based on post mortem human subject sled tests. Stapp Car Crash J. November; 55:91-115, 2011).

Sled Testing of Seatbelt Pretensioning in Rear Impacts: There have been a number of studies of seatbelt pretensioning in rear sled tests. The results have found minimal or no effects on occupant kinematics and biomechanical responses in comparison tests with and without pretensioning up to 40 km/h (25 mph) ΔV. The studies are limited to this severity of tests and use of the 50th Hybrid III dummy. The testing demonstrates the limitations of pretensioners designed for frontal impacts when activated in a rear impact.

Sled Testing of Buckle Pretensioning: In an evaluation of buckle pretensioning in 40 km/h (25 mph) delta V rear sled tests (Viano D C, Parenteau C S, Burnett R. Influence of Belt Pretensioning on Dummy Responses in 40 km/h Rear Impact Sled Tests. Traffic Injury Prevention, 13(1):65-71, 2012), the buckle pretensioner was pyrotechnic and pulled down on the inboard stock of the seatbelt latch. This acted simultaneously on the lap and shoulder belts. The first test involved standard lap-shoulder belts and the second test involved lap-shoulder belts with the buckle pretensioner activated at 20 ms. The belt systems were identical except for the buckle pretensioning. It was a 3-point continuous loop system (lap-shoulder belts) with a sliding latch plate, webbing routed through a D-ring and a single retractor mounted at the base of the B-pillar.

Dummy kinematics were essentially similar with and without belt pretensioning in the 40 km/h (25 mph) rear sled tests. The same was true of the biomechanical responses, which were below tolerances in both situations and similar in level. While there were higher belt loads with pretensioning, they were transient and did not result in a sustained load or different dummy lumbar spine loads or pelvic, chest or head accelerations. The buckle pretensioning did not influence dummy responses as the seat supported the dummy, consistent with other studies. (Tavakoli M S, Brelin-Fornari J, Shetty V. Effect of seat belts equipped with pretensioners on rear seat adult occupants in high severity rear impact. SAE 2008-01-1488, Society of Automotive Engineers, Warrendale, Pa., 2008; Ashline T, Bock H. Investigating the Effects of Anchor Pretensioners. Knee Bolster Airbags and Seat Belt Changes in an IRL Tub. SAE 2004-01-3563, SAE International, Warrendale, Pa., 2004). The seat used in the tests was a 2004-08 Ford F-150, single-recliner seat with a peak moment of 1,657 Nm (14,658 inlb) and peak force of 4,660 N (1,047 lb) in a body block test. (Viano D C, White S. Seat strength in rear body block tests. Traffic Inj Prev. 17(5):502-507, 2016).

The lap belt is seen moving rearward with the occupant as the seatback rotates. The dummy ramps up the seatback and the lap belt does not hold the pelvis down on the seat cushion. The belts do not provide restraint in either test until rebound. The seat provides the restraint and retention of the occupant. The tests show that Hybrid III dummy kinematics and biomechanical responses are similar with and without buckle pretensioning.

There were six reasons that the findings were reasonable and expected. First, the rearward movement of the dummy is away from the lap and shoulder belts causing unloading because of the initial forward orientation of the lap and shoulder belts on the occupant and rearward movement of the dummy. The occupant has to move rearward or ramp sufficiently to re-tighten the belt. Second, the belts wrap around and forward of the dummy's pelvis and chest. The lap belt has a 24 deg forward angle as it wraps around the pelvis. The lap belt would have to move to 24 degrees rearward of vertical to have the same height on the pelvis, assuming a simple arc motion of the lap belt and horizontal movement of the pelvis.

Third, buckle pretensioning caused a spike in belt load with a short duration, transient increase in force that did not sustain tension in the belts. The pretensioner pulled the buckle down 7.7 cm (2.25″) and loaded the lap and shoulder belts. The length of webbing was 80.0 cm (31.5″) from the outboard floor anchor to the sliding latch plate and an additional 78 cm (30.75″) from the sliding latch plate to the D-ring. The buckle movement involved just 7% of the available webbing length, which is not sufficient to sustain tension and offset the geometry of the belts that wrap forward and around the occupant. Pretensioning did not have an effect until late, during rebound.

Fourth, the increase in belt load during the test with pretensioning was not sufficient to change the lumbar loads or accelerations of the occupant's pelvis, chest or head. The dummy responses were essentially similar.

Fifth, the strength of the seat at 1,657 Nm (14,658 inlb) moment was sufficient to provide occupant restraint in the rear sled tests. (Viano D C. Seat Design Principles to Reduce Neck Injuries in Rear Impacts. Traffic Injury Prevention 9(6): 552-560, 2008). The occupant pocketing into the seatback held the dummy with some ramping and the yielding of the seatback provided gradual acceleration through the ΔV of the test. Sixth, the lap-shoulder belts are under tension in normal use from the windup spring in the retractor. The spring force is designed to eliminate slack and keep the belts snug on the occupant. The belts are snug and the pretensioner does not have sufficient energy to pull in much webbing.

Sled Testing of Retractor and Anchor Pretensioning: Retractor only and retractor and anchor pretensioning was tested at 40 km/h (25 mph) delta V rear sled tests. (Viano D C, Burnett R, Miller G A, Parenteau C S. Influence of Retractor and Anchor Pretensioning on Dummy Responses in 40 km/h Rear Sled Tests. Traffic Injury Prevention, 22:5, 396-400, 2021). The pretensioners were pyrotechnic. The retractor pretensioner pulled in shoulder belt webbing by backwinding the spoon for the webbing. The anchor pretensioner was a buckle-pretensioner type actuator. The first test involved the standard lap-shoulder belts, the second test involved the lap-shoulder belts with retractor and anchor pretensioner firing at 60 ms and the third test involved the lap-shoulder belts with retractor pretensioner firing at 60 ms. The belt system was identical except for the pretensioning.

The tests were conducted with a 2013-2018 Ford Escape seat and buck. The Escape seat uses dual recliners, which are typically stronger than single recliner seats. (Viano D C, White S. Seat strength in rear body block tests. Traffic Inj Prev. 17(5):502-507, 2016). Body block testing of a 2016 Ford Escape gave a peak moment of 2,520 Nm (22,299 inlb) and peak force of 7,089 N (1,593 lb).

Occupant kinematics in 40 km/h (25 mph) tests of (1) standard lap-shoulder belt kinematics (2) retractor and anchor pretensioning and (3) retractor pretensioning revealed that the rearward movement of the occupant was essentially the same in the three tests. The shoulder belt is seen tightening in the center and right photos at 100 ms with retractor pretensioning. This pulls the buckle and latch inboard and rotates the stalk upward, lifting the lap belt in some circumstances. (Viano D C, Parenteau C S. Analysis of Rear Sled Tests with the 5th Female Hybrid III: Incorrect Conclusions in Bidez et al. SAE 2005-01-1708. SAE 2019-01-0618, Society of Automotive Engineers, Warrendale, Pa., 2019).

The driver seat yielded rearward and had similar deformation by occupant loading. There were no significant differences in occupant dynamics with and without retractor or retractor and anchor pretensioning in the tests. Belt pretensioning did not influence biomechanical responses in the rear impact as the seat supported the occupant in these tests. All of the responses were well below tolerance or IARV (injury assessment reference values). Any differences were within test-to-test variability in occupant responses.

As with the buckle pretensioning tests, the lap belt is seen moving rearward with the occupant as the seatback rotates. The dummy ramps up the seatback and the lap belt does not hold the pelvis down on the seat cushion. The belts do not provide restraint in the tests until late in rebound. The seat provides the restraint and retention of the occupant. These tests show that Hybrid III dummy kinematics and biomechanical responses are similar with and without buckle pretensioning.

Other Pretensioning Tests in Rear Impacts: In a summary of 14 rear impact sled tests with seatbelt pretensioning (Parenteau C S, Viano D C, Burnett R A. Early Evaluations of Pretensioner Activation in Rear Impacts. Traffic Injury Prevention, DOI: 10.1080/15389588.2021.1946523, 2021), the tests were run in a variety of conditions with an instrumented Hybrid III. They found no benefit of retractor pretensioning with in-position and out-of-position (OOP) seating with a single-recliner 2000-2003 Ford Taurus seat. The body block strength was 1,708 Nm (15,120 inlb) with 4,804 N (1,080 lb) with a 2002 Taurus seat. The results with the older seats are consistent with ones obtained with more modern seats. (Viano D C, Parenteau C S, Burnett R. Influence of Belt Pretensioning on Dummy Responses in 40 km/h Rear Impact Sled Tests. Traffic Injury Prevention, 13(1):65-71, 2012; Viano D C, Burnett R, Miller G A, Parenteau C S. Influence of Retractor and Anchor Pretensioning on Dummy Responses in 40 km/h Rear Sled Tests. Traffic Injury Prevention, 22:5, 396-400, 2021). There was no significant benefit in pretensioning in the rear sled tests up to 40 km/h. The effect of pretensioning has not been assessed at speeds higher than 40 km/h (25 mph). The amount of seatback rotation has progressively decreased in the 40.2 km/h (25 mph) sled tests, as yielding is provided by pocketing of the pelvis into the perimeter frame of the seatback providing ride-down and seats have increased in strength. (Viano D C, Burnett R, Miller G A, Parenteau C S. Influence of Retractor and Anchor Pretensioning on Dummy Responses in 40 km/h Rear Sled Tests. Traffic Injury Prevention, 22:5, 396-400, 2021; Viano D C, White S. Seat strength in rear body block tests. Traffic Inj Prev. 17(5):502-507, 2016). One goal of pocketing into the seatback is to maintain a more horizontal if not downward trajectory of the pelvis as it moved rearward. (Viano D C, Role of the Seat in Rear Crash Safety. SAE Book, ISBN 0-7680-0847-6, Society of Automotive Engineers, Warrendale, Pa., SAE R-317:1-491, 2002). Efforts to maintain a horizontal or downward trajectory of the hip are beneficial in keeping the head low with respect to the head restraint. The displacement of the hip depends on the compliance of the seatback and amount of pocketing, the strength of the seat, and the dynamic friction between the occupant and the seatback. It would be enhanced by downward and forward load in the lap belt.

Sled testing in rear impacts up to 40 km/h (25 mph) delta V shows essentially no benefit with buckle, retractor only or retractor and anchor pretensioning. These pretensioners were designed for frontal impacts. Pretensioning the seatbelts does not have an effect because the occupant pockets into the seatback as it yields rearward with some ramping up the seatback and the geometry and orientation of the lap belt does not promote restraint in a rear impact. As a result, seatbelts do not have a primary role in restraining the occupant in rear impacts at these severities. The yielding seat provides the necessary acceleration forward through the rear delta V and it is not unexpected that pretensioning did not have an effect on occupant kinematics or biomechanical responses.

The rear sled tests show that buckle, retractor and anchor pretensioning has essentially no effect on occupant restraint in a rear impact. The restraint is provided by the seat, which has enough strength to support the 50th Hybrid III dummy in the tests up to 48 km/h (25 mph). The production seats performed with very low biomechanical responses in the dummy and favorable kinematics. (Viano D C, Parenteau C S, Burnett R. Influence of Belt Pretensioning on Dummy Responses in 40 km/h Rear Impact Sled Tests. Traffic Injury Prevention, 13(1):65-71, 2012; Viano D C, Parenteau C S, Burnett R, Prasad P. Occupant Responses in Conventional and ABTS Seats in High-Speed Rear Sled Tests with a Normally Seated Dummy. Traffic Injury Prevention, 2; 19(1):54-59, 2018; Parenteau C S, Viano D C, Burnett R A. Early Evaluations of Pretensioner Activation in Rear Impacts. Traffic Injury Prevention, DOI: 10.1080/15389588.2021.1946523, 2021). However, the start of unfavorable kinematics is seen with some ramping up the rotated seatback and the head rising above the top of the head restraint.

Serious Injury in Rear Impacts: There are a number of real-world rear impacts with serious injury to an occupant. New injury mechanisms have been identified as seats have become stronger over the past two decades and remain more upright in rear impacts. Most of the mechanisms involve very severe crashes, often heavy occupants and unusual crash circumstances.

One of the mechanisms is hyper-extension around the upright seatback frame causing fracture-dislocation of the thoracic spine. (Viano D C. Fracture-Dislocation of the Thoracic Spine in Extension with Upright Seats in Severe Rear Crashes. SAE 2011-01-0274, Society of Automotive Engineers, Warrendale Pa., 2011). Four cases were identified of the upper body hyper-extending rearward around the frame of the seatback. The fractures were very severe and often involved complete transection of the thoracic spine with hyper-extension around the upright frame of the seat.

A second mechanism involved ramping up the seatback with impact on rear surfaces sufficient to cause serious injury. The occupants were lap-shoulder belted and sometimes, the pretensioners triggered in the rear impact but the seatback rotation and energy caused ramping. In some cases, the head restraint is lifted off the seatback with broken guides or posts.

A third mechanism involved over-ride of the rear of the struck vehicle. The over-ride pushed the rear of the vehicle down, dropping the seat under the front occupant. This induced ramping as the inertia of the occupant holds them in space as the seat drops from under them causing ramping.

Another mechanism has been seen in lower-speed rear impacts. It involves thoracic spinal fracture with the occupant on the seat and experiencing forces on the chest that extend the spine. (Viano D C, Parenteau C S, White S. Influence of DISH, Ankylosis, Spondylosis and Osteophytes on Serious-to-Fatal Fracture-Dislocation of the Spine and Spinal Cord Injury in Rear Impacts. SAE 2019-01-1028, Society of Automotive Engineers, Warrendale, Pa., 2019). Such an injury is beyond the scope of the study but is an area of future research. The occupant is accelerated forward with forces from the seatback on the torso.

B. Different Configurations of the Belt Assembly

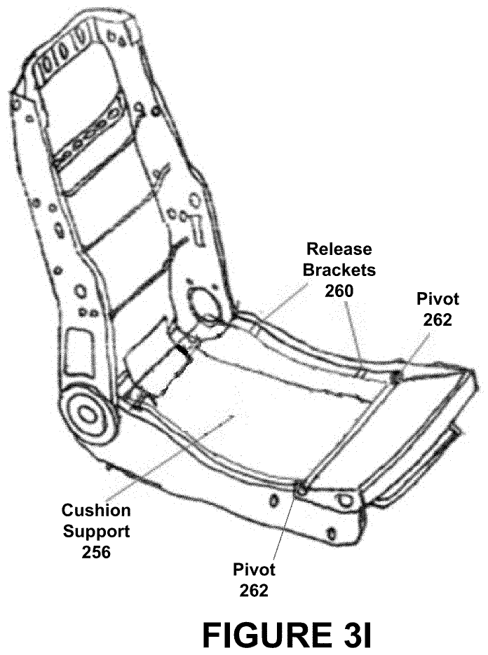

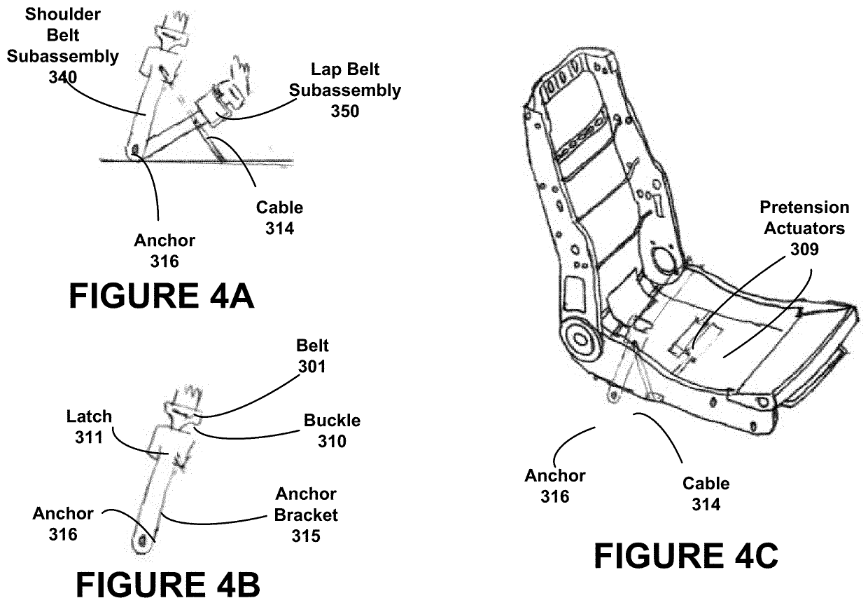

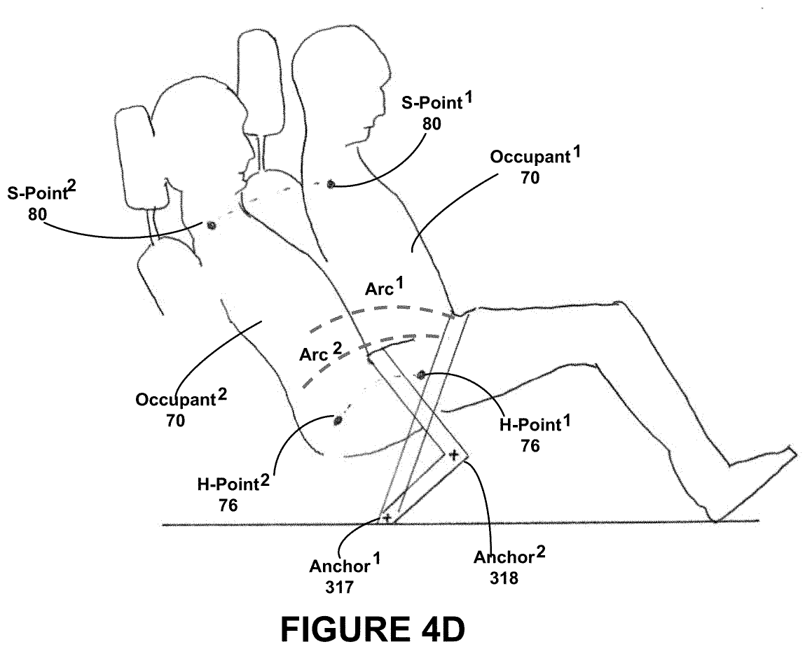

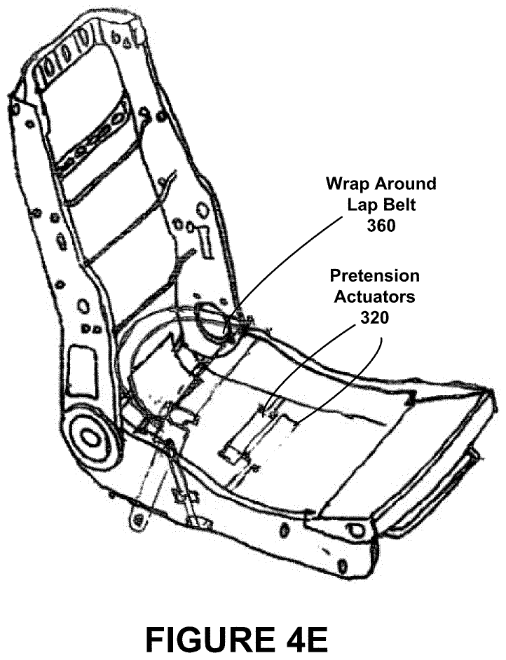

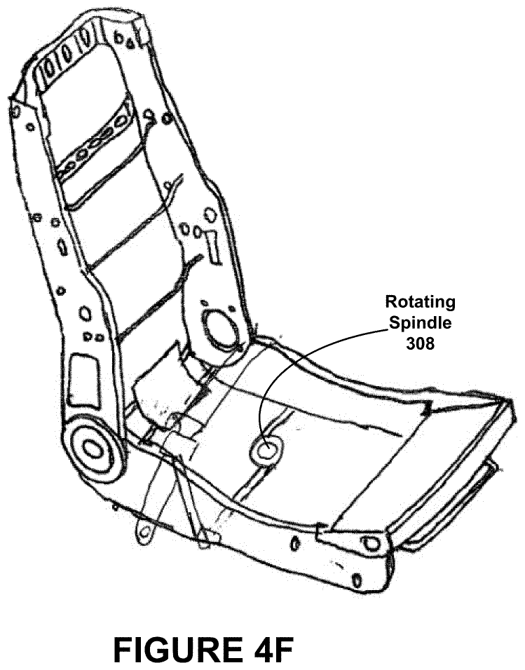

FIG. 4A is a side view diagram illustrating an example of a belt assembly 300 that includes a shoulder belt subassembly 340 and a lap belt subassembly 350 connected to an anchor 316 and a cable 314.

FIG. 4B is a diagram illustrating an example of different components of a belt assembly 300. Illustrated in the drawing are examples of a belt 301, a buckle 310, a latch 311, an anchor 316, and an anchor bracket 315,

FIG. 4C is a perspective diagram illustrating an example of components of the belt assembly 300 as they are positioned relative to the seat assembly 200. The three FIGS. 4A-4C shows the seat and anti-ramping guide 272 with the lap belt 350 portion of the lap-shoulder belt system. The actuators 320 for the rear pretensioners 305 are positioned in the seat cushion. In this embodiment, two buckle pretensioners 324 are used facing in opposite directions. The cables 314 from the actuator are routed through or around the bottom of the side member of the seat cushion frame and up connecting to the inboard and outboard lap belt.

The rear sled tests up to 48 km/h (25 mph) ΔV found essentially no lap belt load during the rearward movement of the dummy. (Viano D C, Parenteau C S, Burnett R. Influence of Belt Pretensioning on Dummy Responses in 40 km/h Rear Impact Sled Tests. Traffic Injury Prevention, 13(1):65-71, 2012; Viano D C, Burnett R, Miller G A, Parenteau C S. Influence of Retractor and Anchor Pretensioning on Dummy Responses in 40 km/h Rear Sled Tests. Traffic Injury Prevention, 22:5, 396-400, 2021). A purpose of the rear pretensioner 305 is to move the anchor 316 locations for the lap belt 350 forward and up, so restraining loads develop early in a rear impact to retain the occupant 70 on the seat cushion. The latch plate 311 used with the restraint system should be a one-way design that allows webbing 318 to pass into the shoulder belt but prevents webbing 318 passing into the lap belt 350 in a crash, which loosens the lap belt 350 and reduces occupant restraint.

A purpose of the anti-ramping guide 272 is to couple the hip to the shell 274 of the guide by the downward pull of the lap belt 350 and control the trajectory of the hip rearward and downward by bending the deformable brackets 276 attached to the seat cushion frame 235. Another purpose of the rear pretensioner 305 is to change the position and orientation of the lap belt 350 so load develops early in the lap 350 belt to restrain the occupant by forces supported by the seat cushion frame in a rear impact. Both the inboard and outboard anchors change position with rear pretensioning to restrain the occupant 70 on the seat cushion and control the trajectory of the H-point 76 and S-point 80 during the rear impact 62.

A purpose of the rear pretensioner 305 is to provide early restraint of the occupant by a load-path from the lap belt into the seat cushion frame 235. This reduces the forces on the seatback and reduces the loads supported by the recliners 232. This is beneficial in lowering the deformation of the seatback.

FIG. 4D is a side view diagram illustrating an example a belt assembly 300 preventing undesirable kinematics 92 in the context of a rear impact 62. FIG. 4D shows the change in arc length of the lap belt and different path of the belt 301 when the anchor 316 location is moved forward and upward by rear pretensioning 305. It also shows the arc of the lap belt with the initial anchor and the shorter arc with the anchors 316 moved up and forward by rear pretensioning. The shorter arc of webbing 318 causes a downward force on the hip by restraining loads in the lap belt that pull the hip down into the anti-ramping guide 272 early in a rear impact 62. Without shortening the arc length, the hip and lower torso gain speed with respect to the seat increasing the tendency to slide out of the lap belt, which develops essentially no restraining loads in tests up to 48 km/h (25 mph).

The lap belt anchor 316 is initially low on the track or floor. Rear pretensioning moves the anchors 316 to a new position on the seat frame for the remained of the crash. By moving the anchor up and forward, the radius of the lap belt webbing passing over the occupant is reduced. In another embodiment, the anchors 316 have a load-limiting attachment 302 to the seat in the new position to improve control of occupant motion.

The restraining loads in the lap belt 350 hold the occupant 70 on the seat reducing the potential for ejection. Ejection is defined as the occupant moving outside the occupant compartment of the vehicle. It has been determined that the lap belt was the primary restraint preventing ejection from the vehicle in rear impacts. (Evans L. Traffic Safety and the Driver. Van Nostrand Reinhold, ISBN 0-442-00163-0, 1991). The Evans study reported the lap belt provided 23% of the overall 49% effectiveness of seatbelts in preventing fatal injury in rear crashes. The rear pretensioner 305 is intended to increase the seatbelt effectiveness in rear impacts.

The inboard lap belt has the buckle and stalk connected to the base of the seat at the upper track or floor. There are a variety of stalk types including a cable 314, seatbelt webbing 318 with a plastic shield and a metal strap connected to the buckle 310 for the seatbelt and latch plate 311. On the inboard side, the rear pretensioner cable is attached below the buckle 310. When the rear pretensioner 305 deploys, it pulls the buckle 310 downward and forward tightening the lap belt and loading the thighs. Some metal stalks have stops limiting the forward and rearward rotation of the buckle 310 during normal use of the seatbelt 301. The pull force of the rear pretensioner 305 needs to be sufficient to overcome or bypass the forward stop to move the stalk to the new anchor 316 position.

On the outboard side, the lap belt webbing 318 attaches directly to a floor or track anchor 316 or a front impact anchor pretensioner. The cable 314 for the rear pretensioner 305 attaches to a clamp or bracket around the lap belt that is attached after the seatbelts are installed in the vehicle. The bracket is held in position and moves forward and downward when the rear pretensioner 305 is deployed. This provides a new anchor 316 position for the lap belt 350.

Sequencing Pretensioner Activation: The rear pretensioner 305 adds to the other pretensioners 304 used in the seatbelt system of modern vehicles. In a rear impact 62, the activation of the pretensioners is sequenced. The rear pretensioner 305 is activated first, earliest in the rear impact 61. This triggering logic allows the lap belt 350 to be snugged on the thighs and sets the anchor 316 points forward and up so the lap belt 350 pulls the occupant 70 down into the seat cushion 235 and anti-ramping guide 272. The retractor pretensioner 305 is triggered second to remove slack from the shoulder belt 340 as the torso 74 moves rearward. The anchor pretensioner is triggered last to remove any remaining slack in the lap belt. The delays in triggering depend on the activation times for the various pretensioners and are staggered to prevent interference between the pretensioner functions.

FIG. 4E is a perspective diagram illustrating an example of a belt assembly 300 that includes a wrap-around lap belt 360 and two pretension actuators 320. The figure shows an embodiment with a wrap-around lap belt 360 added to the lap belt 350. The added loop of webbing 318 behind the occupant is described in U.S. Pat. No. 10,946,829 titled “Wrap Around Seatbelt” that was issued by the USPTO on Mar. 16, 2021. The other components can be the rear pretensioner 305 and anti-ramping guide 272. The addition of seatbelt webbing 318 to wrap around the back of the hip provides additional restraint of the occupant in a rear impact 62. The movement of the lap belt anchors forward and upward tightens the wrap-around belt providing earlier restraint of the hip in rear impacts.

FIG. 4F is a diagram that resembles FIG. 4E except that is illustrates an example of a rotating spindle 308 that uses a single pyrotechnic actuator 322. FIG. 10 shows a second embodiment with the rear pretensioner 305 as a single pyrotechnic unit 322 with a rotating spindle similar to that used in retractor pretensioners. The rotating spindle tightens both cables 314 simultaneously with a single pyrotechnic actuator. There are other means to move the lap-belt anchors to provide restraint in rear impacts.

### VII. COMBINED EMBODIMENTS

The seat assembly 200 and belt assembly 300 can be implemented in a vehicle 50 without the other assembly, but it will often be advantageous to implement both assemblies with components designed to avoid undesirable kinematics 91 and to direct the movement of the occupant 70 so the occupant experiences desirable kinematics 92.

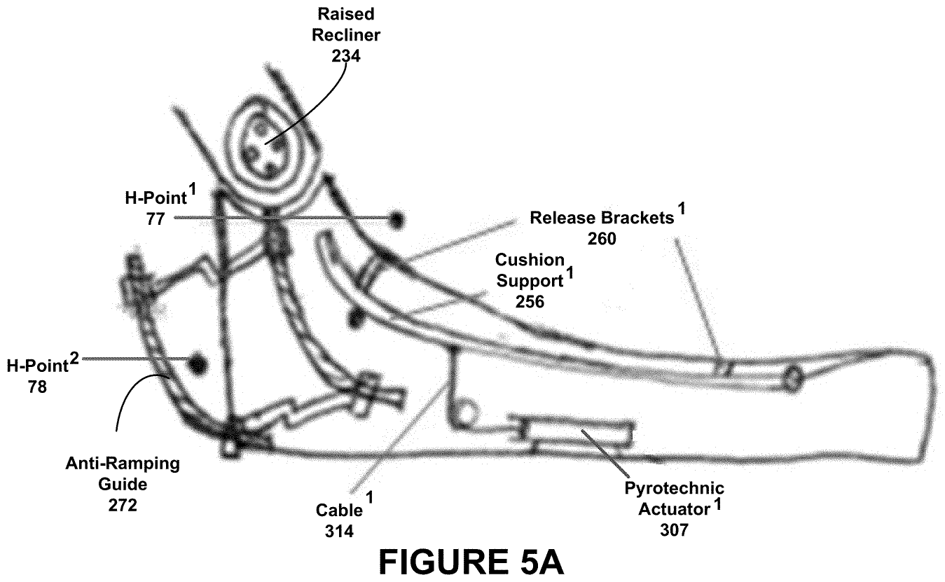

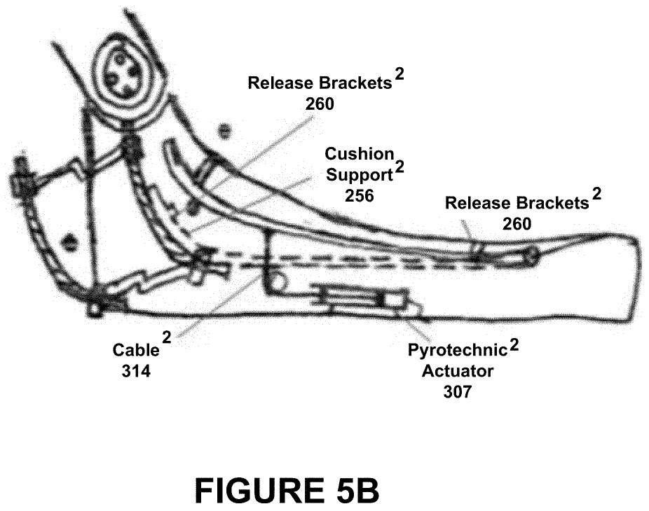

FIG. 5A is a diagram that illustrates an example of a side view of a system 100 prior to a rear collision 62 that includes both an anti-ramping guide 272 within the seat assembly 200 and the cable tightening functionality of the belt assembly 300 that is triggered by a sensor 110 to fire a pyrotechnic actuator 307 in the event of a rear impact 62.

FIG. 5B is a side view diagram that corresponds to the configuration of components in FIG. 5A during a rear-end collision. The cushion support 256 is connected to the side frames of the seat by release brackets 260. The trigger releasing the brackets 260 also triggers a pyrotechnic actuator 307, which pulls the central support structure of the seat cushion into the anti-ramping guide 272. The pyrotechnic actuator 307 may be a buckle pretensioner type actuator. The cushion support 256 dropping facilitates the downward movement of the pelvis by gravity or the rear impact belt pretensioner 305 aligning the H-point 78 with the anti-ramping guide 272. The central support is pulled down at the rear and pivots about the anti-submarining ramp at the front. This maintains the anti-submarining ramp in position if there is a frontal impact after the rear crash in a multi-impact collision.

### VIII. PROCESS-FLOW VIEWS

### A. Example #1

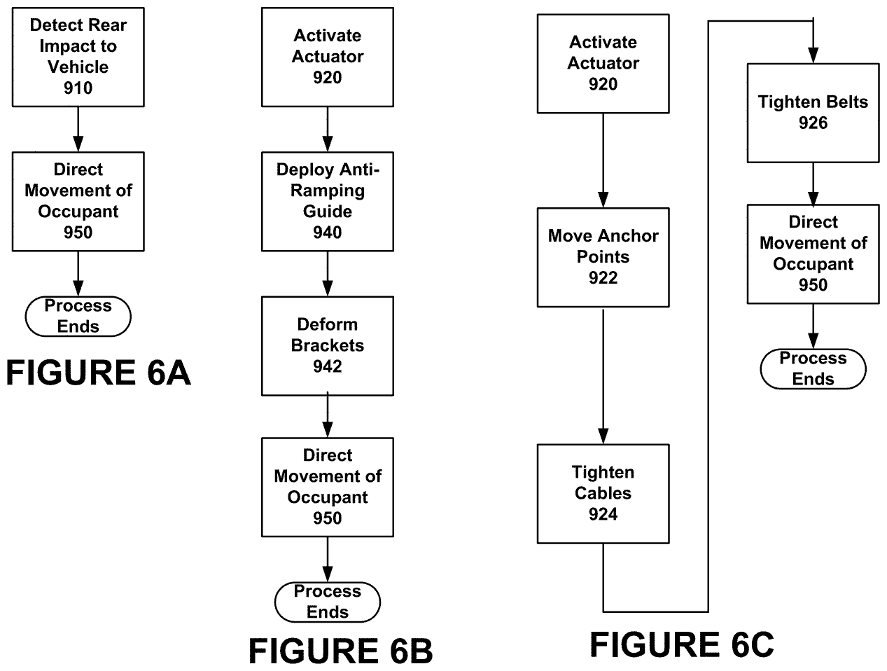

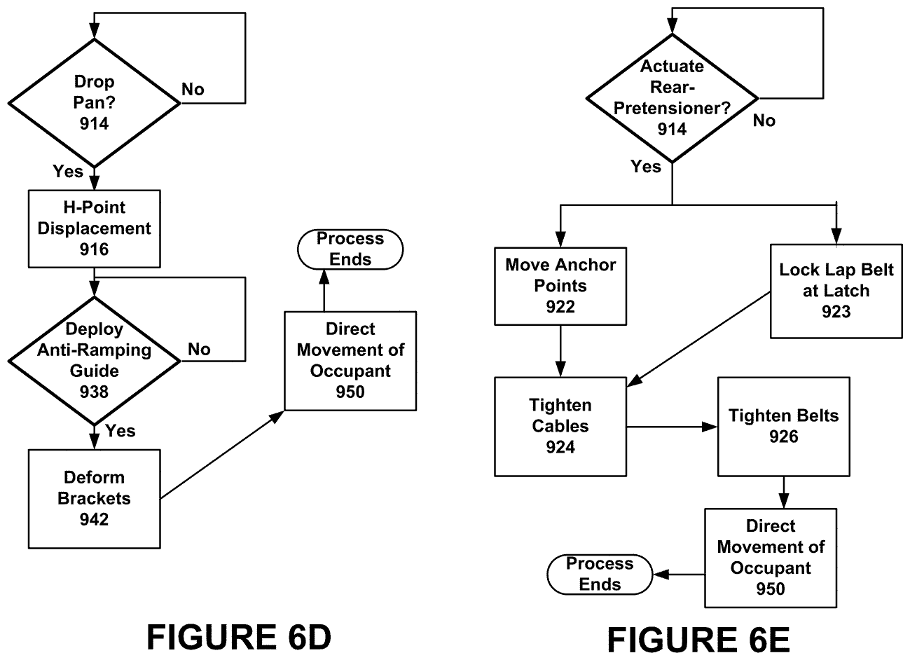

FIG. 6A is a flow chart diagram illustrating an example of the system 100 being used to obtain desirable occupant kinematics 92 by directing the movement of the occupant in rear impact collision 62.

At 910, the rear impact 62 to the vehicle 50 is detected. This can be done through one or more sensors 110 that are in communication with the system 100.

At 950, the system 100 can then direct the movement of the occupant 70 in such a manner as to avoid undesirable kinematics 91 and to facilitate the experience of desirable kinematics 92. This can be achieved using the anti-ramping guide 272 of the seat assembly 200 and/or the rear-pretensioner 305 of the belt assembly 300.

### B. Example #2

FIG. 6B is a flow chart diagram illustrating an example of an anti-ramping guide 272 being deployed to direct the movement of an occupant 70 during a rear impact 62.

At 912, an actuator 320 such as pyrotechnic actuators 322 are activated in response to one or more sensors 110 detecting a rear impact 62.

At 940 the anti-ramping guide 272 is deployed in response to a rear impact and may include activation of the actuator 320.

At 942 the deformable brackets 276 are deformed under the controlled load of the occupant 70.

At 950, the movement of the occupant 70 is successfully directed consistent with desirable kinematics 92.

### C. Example #3

FIG. 6C is a flow chart diagram illustrating an example of a rear-pretensioner 305 being used to tighten one or more safety belts 301 to direct the movement of an occupant 62 in a rear impact 62.

At 912, an actuator 320 such as a pyrotechnic actuator 322 is activated in response to one or more sensors 110 detecting a rear impact 62.

At 920, the sensor 110 triggers the actuator 320 rotating the spindle 308.

At 922 the rotating spindle 308 causes the movement of the locations of the anchors 316.

At 924, the movement of the anchors 316 causes the tightening of the cables 314.

At 926, the tightening of the cables 314 triggers the tightening of the belts 301.

At 950, the tightened belts 301 direct the movement of the occupant 70 in a manner that is consistent with desirable kinematics 92.

### D. Example #4

FIG. 6D is a flow chart diagram illustrating an example of the method 900 utilizing the components of the seat assembly 200 to direct the movement of an occupant 70 in a rear impact 62.

At 914, release brackets 260 shall vertically lower the cushion frame 256 during a rear impact 62 upon a rear impact 62 being detected. Until a rear impact 62 is detected, the loop repeats itself.

At 926, H-point displacement occurs in response to the lowering of the cushion frame 256.

At 938, the system 100 determines whether to deploy the anti-ramping guide 272 which can be achieved by deforming the deformable brackets 276 at 942.

At 950, the system 100 is configured to direct the movement of the occupant 70 in such a manner that the occupant 70 experiences desirable kinematics 92.

### E. Example #5

FIG. 6E is a flow chart diagram illustrating an example of the method 900 utilizing the components of the belt assembly 300 to direct the movement of an occupant in a rear impact 62.

At 914, the belt assembly 300 waits for the sensor 110 to indicate that a rear impact 62 has occurred, in which case the actuator 320 is activated.

At 922, the location of the anchors 316 are moved.

At 923 the lap belt 350 is locked at the latch 311.

At 924, the cables 314 are tightened.

At 926, the shoulder belt 340 and lap belt 350 are tightened. If there is a wrap-around lap belt 360, that is tightened as well.

At 950, the system 100 is configured to direct the movement of the occupant 70 in such a manner that the occupant 70 experiences desirable kinematics 92.

1. A system (100) for protecting an occupant (70) of vehicle (50) during a rear crash (62), with the occupant (70) having a torso (74) with a mid-hip location of an H-point (76), said system (100) comprising:
a belt assembly (300) within the vehicle (50), said belt assembly (300) including a rear pretensioner (305), a belt (301), and an anchor (316) connecting said belt (301) to the vehicle (50), wherein said rear pretensioner (305) is adapted to move said anchor (316) in a forward and upwards direction during the rear crash (62).

2. The system (100) of claim 1, wherein said belt (301) comprises a webbing (319) or a plurality of webbing that is shortened by the movement of said anchor (316).

3. The system (100) of claim 1, wherein said rear pretensioner (305) comprises an actuator (320) that is adapted to be triggered during the rear crash (62), wherein said actuator (320) is adapted to move said anchor (317) during the rear crash (62).

4. The system (100) of claim 1, wherein said belt assembly (300) includes a plurality of anchors (316), a latch (311), an anchor bracket (315), and a plurality of said belts (301), wherein said plurality of belts (301) include a shoulder belt (340) and a lap belt (350), and wherein said plurality of anchors (316) included a first anchor (316) for said shoulder belt (340), a second anchor (316) for said lap belt (350) and a third anchor (316) for said latch (311) connected to said anchor bracket (315) for said shoulder belt (340) and said lap belt (350).

5. The system (100) of claim 4, said belt assembly (300) further including a plurality of cables (314), and a buckle (310), said plurality of cables (314) including a first cable (314) connecting said second anchor (316) to said lap belt (350) and a second cable (314) connecting said third anchor (315) to said latch (311) securing said shoulder belt (340) and said lap belt (350) with said buckle (310).

6. The system (100) of claim 5, said belt assembly (300) further including a sensor (110), a rotating spindle (308), and a pyrotechnic actuator (322), wherein said sensor (110) is adapted to detect the rear impact (62) to the vehicle (50), wherein said pyrotechnic actuator (322) is activated in response to the detection of the rear impact (62), wherein said rotating spindle (308) is adapted to tighten said first cable (314) and said second cable (314) after being triggered by said sensor (110) detecting a rear impact to fire said pyrotechnic actuator (322) during the rear crash (62).

7. The system (100) of claim 6, wherein there is only one said pyrotechnic actuator (322) and only one said rotating spindle (308) for an entire seat assembly (200).

8. The system (100) of claim 4, said belt assembly (300) further including a wrap-around lap belt (360).

9. The system (100) of claim 1, said belt assembly (300) further comprising a buckle pretension actuator (324) that is triggered in a rear crash (62)

10. The system (100) of claim 1, wherein said belt assembly (300) is adapted to direct the movement the H-point (76) of the occupant (70) in a rearward and downward direction during the rear crash (62).

11. The system (100) of claim 1, wherein the torso (74) of the occupant (70) having a torso angle α (84) relative to the vehicle (50), and wherein said belt assembly (300) is adapted to prevent an increase in a torso angle α (84) that is above a predefined critical torso angle α_{c} (87) for ramping.

12. The system (100) of claim 11, wherein said belt assembly (300) is adapted to maintain the torso angle α (84) less than the predefined critical torso angle α^{c} (87) during the rear crash (62).

13. The system (100) of claim 7, wherein said belt assembly (300) is adapted to maintain the torso angle α (84) during the rear crash (62) between a maximum of about 40 degrees and 60 degrees, and less than the predefined critical angle α_{c} (87) for ramping.

14. The system (100) of claim 1, further comprising a seat assembly (200), wherein said seat assembly (200) includes an anti-ramping guide (272).

15. The system (100) of claim 14, wherein said anti-ramping guide (272) comprises a shell (274) and a plurality of deformable brackets (276).

16. The system (100) of claim 15, wherein said shell (274) is contoured in a curved shape.

17. The system (100) of claim 15, wherein said deformable brackets (276) are adapted to move in a rearward and downward trajectory during the rear impact (62).

18. The system (100) of claim 15, wherein said deformable brackets (276) are attached to a cushion frame (235) in said seat assembly (300).

19. A system (100) for protecting an occupant (70) of vehicle (50) during a rear crash (62), with the occupant (70) having a torso (74) with a mid-hip location of an H-point (76), said system (100) comprising:
a belt assembly (300) within the vehicle (50), said belt assembly (300) including:
a plurality of belts (301), said plurality of belts (310) including a shoulder belt (340) and a lap belt (350);
a latch (311);
a buckle (310);
a plurality of anchors (316) connected to the vehicle (50) and an anchor bracket (315), said plurality of anchors (316) including a first anchor (316) for said shoulder belt (340), a second anchor (316) for said lap belt (350) and a third anchor (316) for said shoulder belt (340) and said lap belt (350) connected through said latch (311) and anchor bracket (315);
a plurality of cables (314) connecting said plurality of anchors (316) to said plurality of belts (301), said plurality of cables (314) include a first cable (314) for said lap belt (350) and a second cable (314) to said third anchor (315); and
a rear pretensioner (305) that is adapted to be triggered by a sensor detecting a rear impact to fire an actuator (320) in response to a rear crash (62);
wherein said rear pretensioner (305) is adapted to move said plurality of anchors (316) for the lap belt in a forward and upwards direction during the rear crash (62).

20. A method (900) for protecting an occupant (70) seated on a belt assembly (300) within a vehicle (50) from a rear impact (62) to the vehicle (50), the belt assembly (300) including a rear pretensioner (305), a belt (301), and an anchor (316) connecting said belt (301) to the vehicle (50), said method (900) comprising:
detecting (910) a rear crash (62) to the vehicle (50); and
directing (950) the movement of the occupant (70) in response to the rear crash (62);
wherein said belt assembly (300) is adapted to prevent a vertical increase in the H-point (76) during the rear crash (62); and
wherein said rear pretensioner (305) is adapted to horizontally move the H-point (76) of the occupant (70) in a rearward direction during the rear crash (62).
